(19) United States
(12) Patent Application Publication
(10) Pub. No.: US 2016/0145285 A1
(43) Pub. Date: May 26, 2016

(54) Bio-Oil Polyols, Alkoxylated Bio-Oil Polyols and Bio-Oil Phenolic Resins

(71) Applicant: BATTELLE MEMORIAL INSTITUTE, Columbus, OH (US)

(72) Inventors: Daniel B. Garbark, Blacklick, OH (US); Herman P. Benecke, Columbus, OH (US); Megan S. Moore, Hilliard, OH (US); Mark J. Perry, Hilliard, OH (US); Jeffrey T. Cafmeyer, Columbus, OH (US)

(21) Appl. No.: 14/897,956

(22) PCT Filed: Jun. 11, 2014
(86) PCT No.: PCT/US2014/042016

§ 371 Date: Dec. 11, 2015

Related U.S. Application Data
(60) Provisional application No. 61/833,882, filed on Jun. 11, 2013.
(60) Provisional application No. 61/833,884, filed on Jun. 11, 2013.
(60) Provisional application No. 61/861,023, filed on Aug. 1, 2013.
(60) Provisional application No. 61/917,931, filed on Dec. 18, 2013.

(51) Int. Cl. C07G 1/00; C08G 14/08; C09J 167/04; C08G 18/76; C08G 18/08; C08G 63/00; C08G 8/20; C08G 18/64

(52) U.S. Cl. CPC C07G 1/00; C08G 8/20; C08G 14/08; C08G 18/6492; C08G 18/7671; C08G 18/14; C08G 63/00; C09J 167/04

(57) ABSTRACT

Methods are provided for producing bio-oil polyols, alkoxylating bio-oil polyols to provide polyols, and for employing the alkoxylated bio-oil polyols for making polymers or copolymers of polyesters or polyurethanes. Compositions and methods are provided for incorporating bio-oils into phenolic resins such as phenol-formaldehyde resin and phenol-formaldehyde-urea resin, as well as hot melt adhesive compositions.

### CROSS-REFERENCE TO RELATED APPLICATIONS

This application claims priority from U.S. Provisional Patent Application Ser. Nos. 61/833,882, filed on Jun. 11, 2013; 61/833,884, filed on Jun. 11, 2013; 61/861,023, filed on Aug. 1, 2013; and 61/917,931, filed on Dec. 18, 2013, the entire contents of which are incorporated herein by reference.

### BACKGROUND

Biomass such as, for example, lignocellulosic substances (e.g., wood), may be subjected to pyrolysis to create a hot pyrolysis vapor. Bio-oil may be extracted from the hot pyrolysis vapor. Bio-oil from pyrolysis of wood may contain a mixture of water, organic acids, aldehydes, phenols, and sugar derivatives. The production and availability of bio-oil and bio-oil derivatives may provide a ready starting material for many chemical transformations. The present application appreciates that developing value added uses for bio-oil and bio-oil derivatives may be a challenging endeavor.

### SUMMARY

In one embodiment, a method for preparing an alkoxylated bio-oil polyol is provided. The method may include providing a bio-oil polyol. The method may also include reacting the bio-oil polyol with a cyclic alkylene oxide in the presence of an alkoxylation catalyst under reaction conditions effective to form the alkoxylated bio-oil polyol.

In another embodiment, a method for producing a copolymer composition is provided. The method may include providing a polymerization precursor mixture configured to form a polymer in combination with a reagent polyol, e.g., an alkoxylated bio-oil polyol. The method may also include reacting the alkoxylated bio-oil polyol with the polymerization precursor mixture under reaction conditions effective to form the copolymer composition.

In one embodiment, a copolymer composition is provided. The copolymer composition may include a copolymerized alkoxylated bio-oil polyol.

In another embodiment, a copolymer article is provided. The copolymer article may include a copolymer composition having a copolymerized alkoxylated bio-oil polyol.

In one embodiment, a method for preparing a phenolic resin is provided. The method may include providing a bio-oil or a bio-oil polyol. The method may also include reacting the bio-oil or the bio-oil polyol with an aliphatic phenolic resin precursor and a phenolic resin catalyst to form the phenolic resin.

In one embodiment, a phenolic resin is provided. The phenolic resin may include a plurality of cross-linked phenols. At least a portion of the cross-linked phenols may be derived from a bio-oil or a bio-oil polyol.

In another embodiment, a phenolic resin article is provided. The phenolic resin article may include a plurality of cross-linked phenols. At least a portion of the cross-linked phenols may be derived from a bio-oil or a bio-oil polyol.

In one embodiment, a method for preparing a hot melt adhesive composition is provided. The method may include providing a bio-oil or a bio-oil polyol. The method may also include curing a hot melt adhesive precursor mixture with the bio-oil or the bio-oil polyol to provide the hot melt adhesive composition.

In another embodiment, a method for forming a hot melt adhesive bond is provided. The method may include melting a hot melt adhesive composition to provide a melted adhesive composition. The melted adhesive composition may include phenols derived from a bio-oil or a bio-oil polyol. The method may also include cooling the melted adhesive composition in contact with a surface to form a hot melt adhesive bond at the surface.

In one embodiment, a method of preparing a polyol bio-oil product is provided. The method may include providing a bio-oil starting material in a reaction mixture. The reaction mixture may include a plurality of reactive oxygen groups. The bio-oil starting material may include at least a portion of the plurality of reactive oxygen groups. The method may also include reacting the bio-oil starting material in the reaction mixture to form a polyol bio-oil product. The polyol bio-oil product may include a plurality of functional groups that include carbon-oxygen bonds. The carbon-oxygen bonds may be formed by reacting the bio-oil starting material in the reaction mixture. The polyol bio-oil product may include a plurality of free hydroxyl groups.

In another embodiment, a polyol bio-oil product for use in forming a polyester or a polyurethane is provided. The polyol bio-oil product may be produced by a process. The process may include providing a bio-oil starting material in a reaction mixture. The reaction mixture may include a plurality of reactive oxygen groups. The bio-oil starting material may include at least a portion of the plurality of reactive oxygen groups. The process may also include reacting the bio-oil starting material in the reaction mixture to form a polyol bio-oil product. The polyol bio-oil product may include a plurality of functional groups including carbon-oxygen bonds formed by reacting the bio-oil starting material in the reaction mixture. The polyol bio-oil product may include a plurality of free hydroxyl groups.

In one embodiment, a method for producing a polymer composition may be provided. The method for producing a polymer composition may include providing a polyol bio-oil product. The method for producing a polymer composition may include conducting a polyester or polyurethane polymerization to form the polymer composition. The polyester or polyurethane polymerization may include reacting the polyol bio-oil as a reagent with one or more monomers or crosslinkers. The polymer composition may covalently incorporate at least a portion of the polyol bio-oil product.

In another embodiment, a polymer composition is provided. The polymer composition may include one or more of a polyester or a polyurethane. The polyester or the polyurethane may covalently incorporate a polyol bio-oil product. The polyol bio-oil product may be provided according to any of the subject matter described herein. The polymer composition may be prepared according to any of the subject matter described herein.

### BRIEF DESCRIPTION OF THE DRAWINGS

The accompanying figures, which are incorporated in and constitute a part of the specification, illustrate example methods and compositions, and are used merely to illustrate example embodiments.

FIG. 1 is a flow diagram of an example method 100 for preparing an alkoxylated bio-oil polyol;

FIG. 2 is a flow diagram of an example method 200 for producing a copolymer composition using an alkoxylated bio-oil polyol;

FIG. 3 is a table of polymer foam properties according to alkoxylated bio-oil polyol incorporation as described in the Examples;

FIG. 4 is a flow diagram of an example method 1100 for preparing a phenolic resin;

FIG. 5 is a flow diagram of an example method 1200 for preparing a hot melt adhesive composition;

FIG. 6 is a flow diagram of an example method 1300 for forming a hot melt adhesive bond;

FIG. 7 is a flow diagram of a method of preparing a polyol bio-oil product;

FIG. 8 is a flow diagram of method for producing a polymer composition using a polyol bio-oil product;

FIG. 9A is a flow diagram outlining a method 400A described in EXAMPLE 4A;

FIG. 9B is a flow diagram outlining a method 400B described in EXAMPLE 4B; and

FIG. 10 is a table of polymer foam properties according to polyol bio-oil product incorporation as described in Examples.

### DETAILED DESCRIPTION

Bio-oil produced from the pyrolysis of wood or other lignocellulosic biomass may contain many components, including water, organic acids, phenols, and sugars. Bio-oil produced by pyrolysis may include bio-oil polyols. By reacting bio-oil with itself or with reagent polyols, e.g., glycerol or 2-methyl-1,3-propanediol, intermediate bio-oil polyol products may be formed, and may be further modified by alkoxylation to produce alkoxylated bio-oil polyols. Such bio-oils, bio-oil polyols, intermediate bio-oil polyols, and alkoxylated bio-oil polyols may have added value, for example, as replacement polyol reagents in polymerizations for forming polyesters, polyurethanes, copolymers, phenolic resins, hot melt adhesive compositions, and the like.

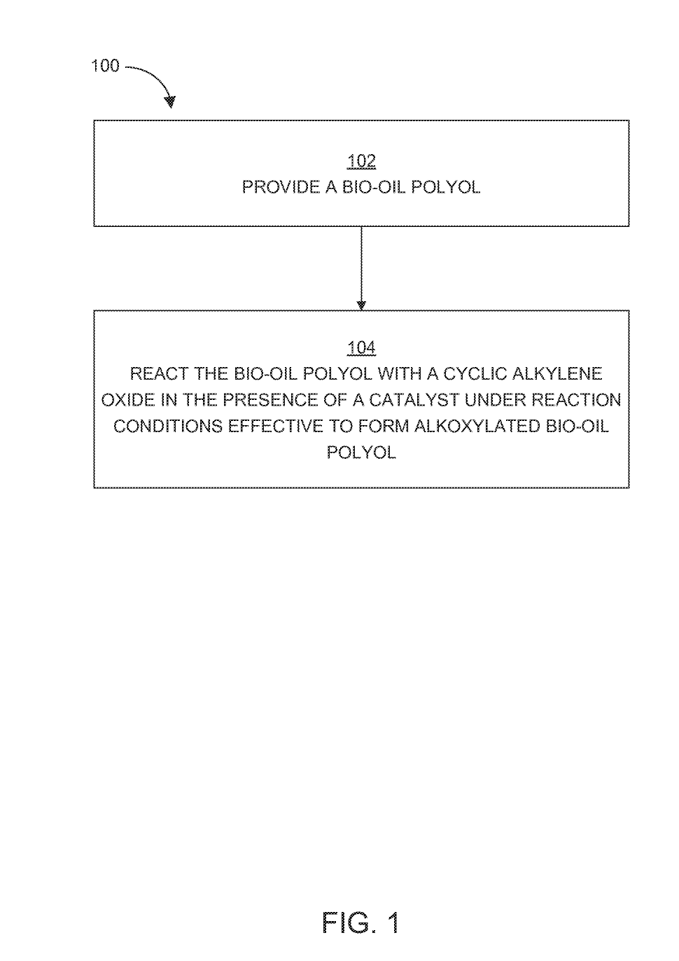

FIG. 1 is a flow diagram of an example method 100 for preparing an alkoxylated bio-oil polyol. Method 100 may include providing a bio-oil polyol (step 102). The method may also include reacting the bio-oil polyol with a cyclic alkylene oxide, such as an epoxide, in the presence of a catalyst, e.g., an alkoxylation catalyst, under reaction conditions effective to form the alkoxylated bio-oil polyol (step 104).

In some embodiments, the cyclic alkylene oxide may include unsubstituted ethylene oxide or substituted ethylene oxide. The substituted ethylene oxide may be substituted with a linear or branched C₁-C₆ alkyl group or a C₃-C₆ cycloalkyl group. For example, the cyclic alkylene oxide may include 1,2-propylene oxide. The cyclic alkylene oxide may be present in a weight % compared to a weight of the bio-oil polyol of about 5%, 10%, 15%, 20%, 25%, 30%, 35%, 40%, 45%, 50%, 55%, 60%, 65%, or 70%, or in a range between about any of the preceding weight % values, for example, between about 5 weight % and about 70 weight %. In some embodiments, the cyclic alkylene oxide may be present in a weight % compared to a weight of the bio-oil polyol of greater than 10 weight %.

In several embodiments, the reaction conditions may include the presence of a catalytic alkali metal hydroxide or a catalytic alkali earth metal hydroxide or oxide. An alkali metal hydroxide may include a hydroxide of Li, Na, K, Rb, or Cs. For example, the reaction conditions may include the presence of a catalytic amount of potassium hydroxide. An alkali earth metal hydroxide or oxide may include a hydroxide or oxide of Be, Mg, Ca, Sr, Ba, and the like. For example, an alkali earth metal hydroxide may include magnesium hydroxide, and an alkali earth metal oxide may include calcium oxide.

In various embodiments, the reaction conditions may include the presence of an acidified lignin. The reaction conditions may include the presence of a catalyst in a weight % compared to a weight of the bio-oil polyol. The weight % of the catalyst may be between about 0.01 weight % and about 10 weight %, for example, a weight % of about 0.01, 0.05, 0.1, 0.15, 0.2, 0.25, 0.3, 0.4, 0.5, 0.6, 0.7, 0.75, 0.8, 0.9, 1, 1.25, 1.5, 1.75, 2.5, 3, 3.5, 4, 4.5, 5, 6, 7, 8, 9, or 10, or any range of weight % between any two of the preceding weight % values, for example, between about 0.01 weight % and about 5 weight %.

In some embodiments, the reaction conditions may include a temperature between about 80° C. and about 180° C. For example, the temperature in ° C. may be 80, 85, 90, 95, 100, 105, 110, 115, 120, 125, 130, 135, 140, 145, 150, 155, 160, 165, 170, 175, or 180, or any range of temperature between any two of the preceding ° C. values.

In several embodiments, the reaction conditions may include a pressure in pounds per square inch (psi) of between about 0 psi and about 600 psi. For example, the pressure in psi may be about 0, 15, 30, 45, 60, 75, 90, 105, 120, 135, 150, 175, 200, 225, 250, 275, 300, 325, 350, 375, 400, 425, 450, 475, 500, 525, 550, 575, or 600, or any range of pressure between any two of the preceding psi values.

In various embodiments, the bio-oil polyol may include a bio-oil, a bio-oil esterified by reaction with itself or a bio-oil esterified by reaction with a reagent polyol. The bio-oil may be produced by pyrolysis of biomass. Additionally or alternatively, the bio-oil may be a catalytic bio-oil produced by catalytic pyrolysis of biomass.

In some embodiments, the method may further include reacting a bio-oil with at least one of itself or a reagent polyol in the presence of a polyol-forming catalyst to provide the bio-oil polyol. For example, the reagent polyol may include one or more of glycerol, ethylene glycol, propylene glycol (1,2-propane diol), 1,3-propanediol, 2-methyl-1,3-propanediol, pentaerythritol, a sugar alcohol, or a polyalkylene glycol. Sugar alcohols may include, but are not limited to, glycerol, ethylene glycol, propylene glycol (1,2-propane diol), 1,3-propanediol, 2-methyl-1,3-propanediol, pentaerythritol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, and the like. Examples of polyalkylene glycols may include, but are not limited to, a polyethylene glycol, a polypropylene glycol, or a poly(tetramethylene ether) glycol, and the like. The reagent polyol may include amine alcohols such as triethanolamine. The reagent polyol may include one or more of acidified and demethylated crude glycerol or wet crude glycerol from steam splitting.

In several embodiments, the polyol-forming catalyst may contribute to reacting the bio-oil in the reaction mixture to form the bio-oil polyol product. Suitable catalysts may be based on metallic compounds of mercury, lead, tin, bismuth, zinc, and the like. Such metallic compounds may include one or more different oxidation states (I), (II), (III), or (IV), for example, tin(II) and tin(IV) compounds. Such metallic compounds of mercury, lead, tin, bismuth, zinc, and the like, may include metallic carboxylates, oxides, mercaptides, and the like. For example, mercury carboxylates, bismuth carboxylates, zinc carboxylates, tin carboxylates and the like may be suitable catalysts. For example, metal carboxylate compounds may include one or more carboxylates. Such one or more carboxylates may include monocarboxylates, or two or more carboxylates in the same organic carboxylate, such as the dicarboxylate oxalate in tin (II) oxalate. Metal carboxylate compounds may also include alkyl carboxylates with one or more pendant alkyl groups, e.g., dialkyl tin dicarboxylates such as dibutyltin dilaurate. For example, the method may include providing a tin (II) oxalate polyol-forming catalyst. The tin (II) oxalate catalyst may contribute to reacting the bio-oil in the reaction mixture to form the bio-oil polyol.

In some embodiments, reacting a bio-oil with at least one of itself or a reagent polyol in the presence of a polyol-forming catalyst to provide the bio-oil polyol may be conducted according to any of the subject matter herein regarding preparing or reacting bio-oil.

In various embodiments, the method may further include contacting an acidified lignin to one or more of the bio-oil, the reagent polyol, or the polyol-forming catalyst. The method may also include pyrolyzing biomass to provide the bio-oil or catalytically pyrolyzing biomass to provide the bio-oil as a catalytic bio-oil.

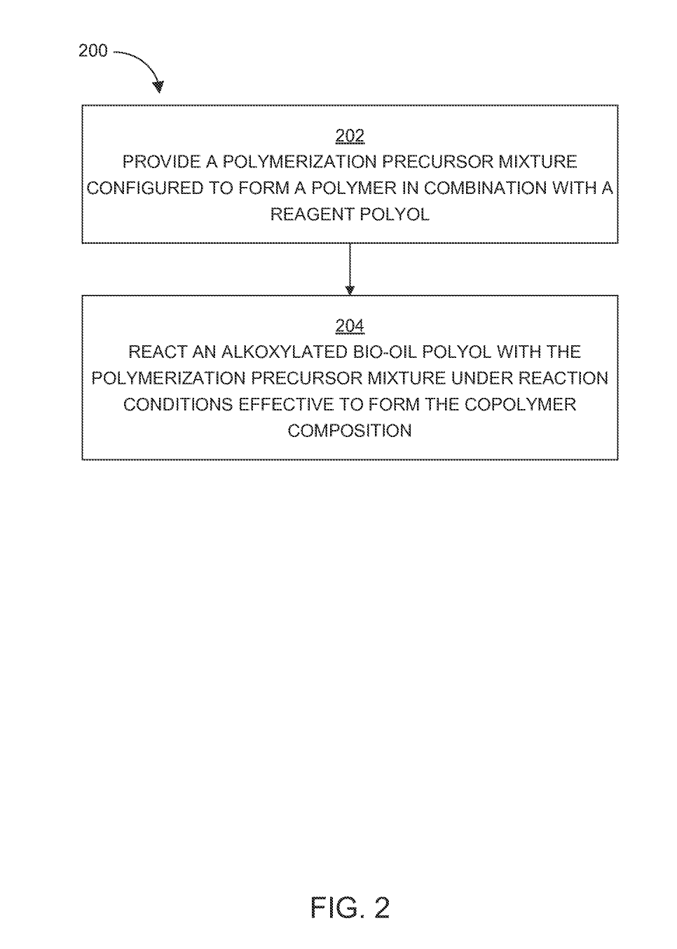

FIG. 2 is a flow diagram of an example method 200 for producing a copolymer composition. Method 200 may include providing a polymerization precursor mixture configured to form a polymer in combination with a reagent polyol (step 202). The method may also include reacting an alkoxylated bio-oil polyol with the polymerization precursor mixture under reaction conditions effective to form the copolymer composition (step 204). The alkoxylated bio-oil polyol may be formed according to any subject matter described herein regarding the alkoxylated bio-oil polyol or forming the alkoxylated bio-oil polyol. The method for producing the copolymer composition may include forming the alkoxylated bio-oil polyol according to any subject matter described herein regarding the alkoxylated bio-oil polyol or forming the alkoxylated bio-oil polyol.

In various embodiments, the polymerization precursor mixture may include an aliphatic phenolic resin precursor and a phenolic resin catalyst as described herein. The polymerization precursor mixture may be effective in reacting with the alkoxylated bio-oil polyol to produce the copolymer composition as a phenolic resin.

In several embodiments, the method for producing the copolymer composition may include contacting a viscosity-reducing modifier to the alkoxylated bio-oil polyol and/or the polymerization precursor mixture.

In various embodiments, the polymerization precursor mixture may include a polyurethane precursor. The polyurethane precursor may be effective to form the copolymer composition including a copolymer of a polyurethane and the alkoxylated bio-oil polyol. For example, the polyurethane precursor may include one or more of toluene diisocyanate, methylene diphenyl diisocyanate, 1,6-hexamethylene diisocyanate, 1-isocyanato-3-isocyanatomethyl-3,5,5-trimethyl-cyclohexane, 4,4′-diisocyanato dicyclohexylmethane, and the like.

In some embodiments, the polymerization precursor mixture may include water. The polymerization precursor mixture may include a petroleum polyol. The polymerization precursor mixture may include the petroleum polyol in a weight % compared to the alkoxylated bio-oil polyol of between about 5 weight % and about 95 weight %, for example, a weight % of about 5, 10, 15, 20, 25, 30, 35, 40, 45, 50, 55, 60, 65, 70, 75, 80, 85, 90, or 95, or any range of weight % between any two of the preceding weight % values. For example, the petroleum polyol in a weight % compared to the alkoxylated bio-oil polyol of between 10 weight % and about 95 weight %.

In several embodiments, the polymerization precursor mixture may include a surfactant configured to support polyurethane foam formation.

In various embodiments, the reaction conditions may include the presence of a catalyst. For example, the catalyst may be a polyurethane polymerization catalyst for reacting the alkoxylated bio-oil polyol with one or more polyurethane precursors as described herein to form the copolymer composition. Suitable polyurethane catalysts may include, but are not limited to, amine compounds, hypophosphite salts, zeolites, metal complexes such as stannous or stannic salts, and combinations thereof. Suitable amine catalysts may include, but are not limited to, tertiary amines such as triethylenediamine, dimethylcyclohexylamine, dimethylethanolamine, and the like. Hypophosphite salts include, for example, alkali metal salts such as sodium hypophosphite and alkali earth metal salts such as calcium hypophosphite, and the like. Catalysts for polyurethane polymerization may be based on metallic compounds of mercury, lead, tin, bismuth, zinc, and the like. Such metallic compounds may include one or more different oxidation states (I), (II), (III), or (IV), for example, tin(II) and tin(IV) compounds. Such metallic compounds of mercury, lead, tin, bismuth, zinc, and the like, may include metallic carboxylates, oxides, mercaptides, and the like. For example, mercury carboxylates, bismuth carboxylates, zinc carboxylates, tin carboxylates and the like may be suitable catalysts. For example, metal carboxylate compounds may include one or more carboxylates. Such one or more carboxylates may include monocarboxylates, or two or more carboxylates in the same organic carboxylate, such as the dicarboxylate oxalate in tin (II) oxalate. Metal carboxylate compounds may also include alkyl carboxylates with one or more pendant alkyl groups, e.g., dialkyl tin dicarboxylates such as dibutyltin dilaurate. For example, the method may include providing a tin (II) oxalate as a catalyst. For example, the polymerization precursor mixture may include a polyamino alkane configured to catalyze polyurethane formation. The polymerization precursor mixture may include a polyalkylamino alkyl ether configured to catalyze polyurethane formation. The polymerization precursor mixture may include an amino alcohol configured to catalyze polyurethane formation.

In various embodiments, the polymerization precursor mixture may include a bio-based polyester polyol. Suitable bio-based polyester polyols may include, but may be not limited to, bio-based polyester polyols, such as Priplast bio-based polyester polyols (Croda USA, New Castle, Del.).

In some embodiments, the polymerization precursor mixture may include one or more of: a petroleum polyol, water, a silicone foam forming surfactant, a trialkylamine in an alkylene glycol, a polyalkylamino alkyl ether in an alkylene glycol, an antioxidant, a flame retardant, an ultraviolet light stabilizer, a pigment, a dye, a plasticizer, and the like.

In several embodiments, the polymerization precursor mixture may include a polyfunctional ester precursor effective to form the copolymer composition, which may include a copolymer of a polyester and the alkoxylated bio-oil polyol. The polyfunctional ester precursor may include one or more of a polycarboxylic acid, a polyacyl halide, or a cyclic anhydride. Examples of suitable polyfunctional ester monomers may include, but are not limited to: diacids such as glutaric, adipic, pimelic, suberic, azelaic, sebacic, dodecanedioic, and tetradecanedioic acids, and the like; diacyl halides of diacids, such as adipoyl chloride, and the like; or cyclic anhydrides of diacids, such as adipic anhydride; and the like.

In various embodiments, the reaction conditions may include the presence of a catalyst. For example the catalyst may be a polyester polymerization catalyst. The polyester polymerization catalyst may contribute to reacting the alkoxylated bio-oil polyol with the polyfunctional ester precursor to form the copolymer composition. Suitable polyester catalysts may include, for example, antimony trioxide, antimony triacetate, alkali hydroxides such as potassium hydroxide, oligomeric aluminoxane, and the like. Further crosslinking may be obtained with organic peroxide catalysts such as methyl ethyl ketone peroxide, benzoyl peroxide, and the like. Catalysts for polyester polymerization may be based on metallic compounds of mercury, lead, tin, bismuth, zinc, and the like. Such metallic compounds may include one or more different oxidation states (I), (II), (III), or (IV), for example, tin(II) and tin(IV) compounds. Such metallic compounds of mercury, lead, tin, bismuth, zinc, and the like, may include metallic carboxylates, oxides, mercaptides, and the like. For example, mercury carboxylates, bismuth carboxylates, zinc carboxylates, tin carboxylates and the like may be suitable catalysts. For example, metal carboxylate compounds may include one or more carboxylates. Such one or more carboxylates may include monocarboxylates, or two or more carboxylates in the same organic carboxylate, such as the dicarboxylate oxalate in tin (II) oxalate. Metal carboxylate compounds may also include alkyl carboxylates with one or more pendant alkyl groups, e.g., dialkyl tin dicarboxylates such as dibutyltin dilaurate. For example, the method may include providing a tin (II) oxalate as a catalyst.

In various embodiments, the reaction conditions may include the presence of a catalyst. The reaction conditions may include a temperature in ° C. of about 0, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, or 225, or any range between the preceding values, for example, between about 0° C. and about 180° C. The reaction conditions may include a pressure in pounds per square inch (psi) of about 60, 75, 90, 105, 120, 135, 150, 175, 200, 225, 250, 275, 300, 325, 350, 375, 400, 425, 450, 475, 500, 525, 550, 575, or 600, or any range between any two of the preceding values, for example, between about 0 psi and about 600 psi.

In some embodiments, the method for producing the copolymer composition may include configuring the copolymer composition as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, an integral skin foam, and the like.

In various embodiments, a copolymer composition is provided. The copolymer composition may include a copolymerized alkoxylated bio-oil polyol.

The copolymer composition may include at least in part a reaction product of the alkoxylated bio-oil polyol copolymerized with an aliphatic phenolic resin precursor and a phenolic resin catalyst effective to produce the copolymer composition as a phenolic resin.

In some embodiments, the copolymer may at least in part incorporate a polyester copolymerized with the alkoxylated bio-oil polyol. The polyester may be incorporated as one or more of a covalently polymerized polyester monomer, crosslinker, oligomer, polymer, or copolymer.

In several embodiments, the copolymer may at least in part incorporate a polyurethane copolymerized with the alkoxylated bio-oil polyol. The polyurethane may be incorporated as one or more of a covalently polymerized polyurethane monomer, crosslinker, oligomer, polymer, or copolymer.

In various embodiments, the alkoxylated bio-oil polyol incorporated in the copolymer composition may be produced according to any subject matter described herein for the method of producing the alkoxylated bio-oil polyol. The copolymer composition may be produced according to any subject matter herein for the method of producing the copolymer composition. The copolymer composition may be configured as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, an integral skin foam, and the like.

In various embodiments, a copolymer article is provided. The copolymer article may include a copolymer composition including a copolymerized alkoxylated bio-oil polyol.

The copolymer composition may be produced according to any subject matter herein for the method of producing the copolymer composition. The alkoxylated bio-oil polyol incorporated in the copolymer composition may be produced according to any subject matter described herein for the method of producing the alkoxylated bio-oil polyol.

Moreover, the copolymer composition may be configured as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, an integral skin foam, and the like.

In various embodiments, a method is provided for preparing a bio-oil polyol, for example, the bio-oil polyol employed in the method of preparing an alkoxylated bio-oil polyol. The method for preparing the bio-oil polyol may include providing a bio-oil in a reaction mixture. The reaction mixture may include a plurality of reactive oxygen groups. The bio-oil may include at least a portion of the plurality of reactive oxygen groups. The method may also include reacting the bio-oil in the reaction mixture to form a polyol bio-oil product. The polyol bio-oil product may include a plurality of functional groups that include carbon-oxygen bonds. The carbon-oxygen bonds may be formed by reacting the bio-oil in the reaction mixture. The polyol bio-oil product may include a plurality of free hydroxyl groups.

In various embodiments, the plurality of reactive oxygen groups may include one or more of free hydroxyls, carboxylic acids, carbonyls, or cyclic alkylene oxides. At least a portion of the plurality of free hydroxyl groups included by the polyol bio-oil product may be derived from a portion of plurality of free hydroxyl groups included by the bio-oil. At least a portion of the plurality of free hydroxyl groups included by the polyol bio-oil product may be formed by reacting the bio-oil in the reaction mixture to transform at least a portion of the plurality of reactive oxygen groups into the at least a portion of the plurality of free hydroxyl groups included by the polyol bio-oil product.

In various embodiments, the method may also include providing one or more of a reagent polyol or a cyclic alkylene oxide to the reaction mixture. At least a portion of the plurality of reactive oxygen groups may be provided by one or more of the reagent polyol or the cyclic alkylene oxide. Reacting the bio-oil in the reaction mixture to form the polyol bio-oil product may include reacting the bio-oil with one or more of the reagent polyol or the cyclic alkylene oxide.

In various embodiments, the method may also include providing a catalyst to the reaction mixture. The catalyst may contribute to reacting the bio-oil in the reaction mixture to form the polyol bio-oil product. Suitable catalysts may be based on metallic compounds of mercury, lead, tin, bismuth, zinc, and the like. Such metallic compounds may include one or more different oxidation states (I), (II), (III), or (IV), for example, tin(II) and tin(IV) compounds. Such metallic compounds of mercury, lead, tin, bismuth, zinc, and the like, may include metallic carboxylates, oxides, mercaptides, and the like. For example, mercury carboxylates, bismuth carboxylates, zinc carboxylates, tin carboxylates and the like may be suitable catalysts. For example, metal carboxylate compounds may include one or more carboxylates. Such one or more carboxylates may include monocarboxylates, or two or more carboxylates in the same organic carboxylate, such as the dicarboxylate oxalate in tin (II) oxalate. Metal carboxylate compounds may also include alkyl carboxylates with one or more pendant alkyl groups, e.g., dialkyl tin dicarboxylates such as dibutyltin dilaurate. For example, the method may include providing a tin (II) oxalate as a catalyst. For example, the method may include providing a tin (II) oxalate catalyst to the reaction mixture. The tin (II) oxalate catalyst may contribute to reacting the bio-oil in the reaction mixture to form the polyol bio-oil product.

In various embodiments, the bio-oil may include at least a portion of the reactive oxygen groups including at least free hydroxyls and free carboxylic acids. Forming the carbon-oxygen bonds may include forming ester bonds between at least a portion of the free hydroxyls and the free carboxylic acids included by the bio-oil.

In various embodiments, the bio-oil may include at least a portion of the reactive oxygen groups including at least free carboxylic acids. The method may also include adding one or more of a reagent polyol or a cyclic alkylene oxide to the reaction mixture. Forming the carbon-oxygen bonds may include forming ester bonds by reacting the free carboxylic acids of the bio-oil with one or more of the reagent polyol or the cyclic alkylene oxide. The added polyol reagent may include one or more of a sugar alcohol, an alcohol amine, or a polyalkylene glycol. Examples of sugar alcohols may include, but are not limited to, glycerol, ethylene glycol, propylene glycol (1,2-propane diol), 1,3-propanediol, 2-methyl-1,3-propanediol, pentaerythritol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, and the like. Examples of polyalkylene glycols may include, but are not limited to, a polyethylene glycol, a polypropylene glycol, or a poly(tetramethylene ether) glycol, and the like. Examples of amine alcohols include triethanol amine and the like.

For example, the added polyol reagent may include one or more of glycerol, ethylene glycol, propylene glycol (1,2-propane diol), 1,3-propanediol, 2-methyl-1,3-propanediol, pentaerythritol, a sugar alcohol, a polyethylene glycol, a polypropylene glycol, or a poly(tetramethylene ether) glycol.

In various embodiments, the added cyclic alkylene oxide may include one or more of ethylene oxide or propylene oxide.

In various embodiments, the method may also include pyrolyzing biomass to provide the bio-oil.

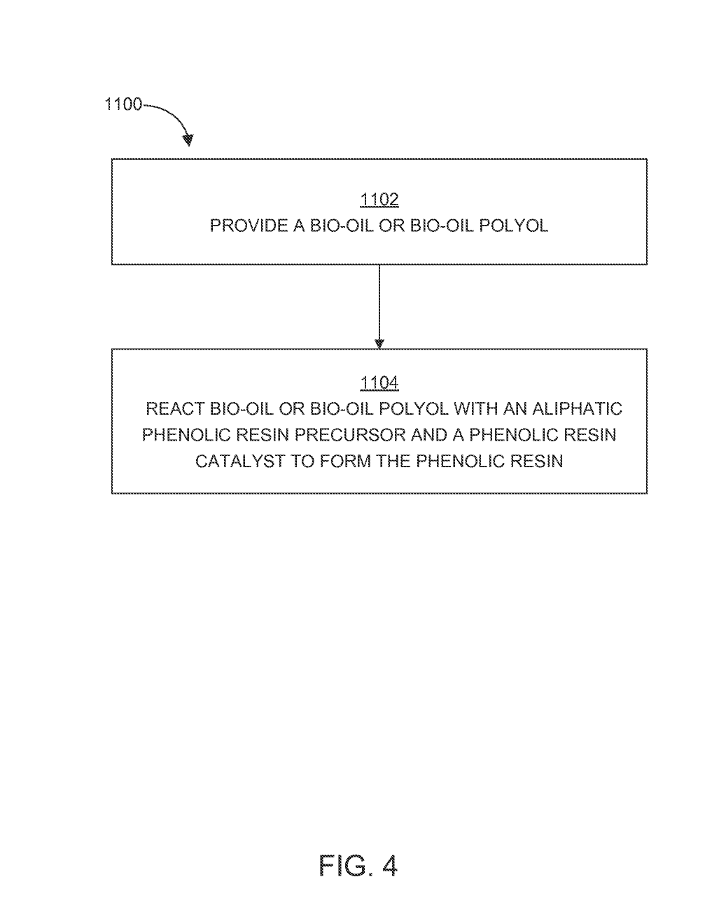

FIG. 4 is a flow diagram of a method 1100 for preparing a phenolic resin according to various embodiments. The method 1100 may include providing a bio-oil and/or a bio-oil polyol (step 1102). The method may also include reacting the bio-oil and/or bio-oil polyol with an aliphatic phenolic resin precursor and a phenolic resin catalyst to form the phenolic resin (step 1104).

In various examples of the method, the bio-oil may include the bio-oil polyol. The bio-oil may include an alkoxylated bio-oil polyol. The alkoxylated bio-oil polyol may be produced by any method described herein.

In some embodiments, the bio-oil may be characterized by an amount of free hydroxyls per gram. For example, at least about 10%, 15%, 20%, 25%, 30%, 35%, 40%, 45%, 50%, 55%, 60%, 65%, 70%, 75%, 80%, 85%, 90%, 95%, or 100% of the free hydroxyls per gram may be phenol hydroxyls, e.g., about 10%. In another example, at least about 40% of the free hydroxyls per gram may be phenol hydroxyls. In a further example, at least about 50% of the free hydroxyls per gram may be phenol hydroxyls.

In various embodiments, the bio-oil may be a phenolic-enriched bio-oil characterized by enrichment in bio-oil phenolic components. The method may include treating bio-oil to remove at least a portion of non-phenolic bio-oil components to provide the phenolic-enriched bio-oil. The method may include treating bio-oil to remove substantially all non-phenolic bio-oil components to provide the phenolic-enriched bio-oil.

In several embodiments, the aliphatic phenolic resin precursor may include one or more of a reactive carbonyl compound (such as an aldehyde derivative), a urea derivative, or a formaldehyde-urea resin. For example, the aliphatic phenolic resin precursor may include one or more of formaldehyde, urea, or a formaldehyde-urea resin.

As used herein, a reactive carbonyl compound is a compound containing a C═O group which may react to cross-link phenol groups in the described phenolic resins. For example, reactive carbonyl compounds may include aldehydes, ketones, ureas, and derivatives thereof. In some embodiments, the reactive carbonyl compound may include two or more reactive carbonyls, such as in a dialdehyde, diketone, and/or combinations and/or derivatives thereof, and the like. Reactive carbonyl compounds with two or more reactive carbonyl groups may provide more effective crosslinking than formaldehyde in some examples. For example, aldehydes may include formaldehyde, acetaldehyde (ethanal), propionaldehyde (propanal), butyraldehyde (butanal), derivatives thereof, and the like. Dialdehydes may include glyoxal (ethane-1,2-dial), propane-1,3-dial, butane-1,4-dial, glutaraldehyde (pentane-1,5-dial), derivatives thereof, and the like. Ketones may include acetone (2-propanone), 2-butanone, 2-pentanone, 3-pentanone, derivatives thereof, and the like. Diketones may include diacetyl (butane-2,3-dione) acetylacetone (pentane-2,4-dione), derivatives thereof, and the like. In some embodiments, reactive carbonyl compounds including aldehydes may be more reactive compared to ketones. In various embodiments, the reactive carbonyl compound may be at least partly water soluble, or in some examples, water-miscible.

In various embodiments, the phenolic resin catalyst may be configured to catalyze formation of one or more of a phenol-formaldehyde resin, a formaldehyde-urea resin, or a phenol-formaldehyde-urea resin. The phenolic resin catalyst may include one of an acid catalyst or a basic catalyst. For example, the phenolic resin catalyst may include one of a carboxylic acid, a carboxylate salt, hydrochloric acid, a sulfonate acid, ammonia, an amine, an amide, an alkylamine, pyridine, an alkali metal hydroxide, an alkali earth metal hydroxide, or an alkali earth metal oxide.

In some embodiments, the bio-oil may be prepared by catalytic pyrolysis of biomass. The bio-oil may be a catalytic bio-oil prepared by catalytic pyrolysis of biomass.

In several embodiments, the reacting the bio-oil with the aliphatic phenolic resin precursor and the phenolic resin catalyst may include reacting the bio-oil with formaldehyde to form the phenolic resin as a phenol-formaldehyde resin. Additionally or alternatively, the reacting the bio-oil with the aliphatic phenolic resin precursor and the phenolic resin catalyst may include reacting the bio-oil with formaldehyde-urea to form the phenolic resin as a phenol-formaldehyde-urea resin. Additionally or alternatively, the reacting the bio-oil with the aliphatic phenolic resin precursor and the phenolic resin catalyst may include reacting the bio-oil with formaldehyde to form a phenol-formaldehyde precursor. Additionally or alternatively, the reacting the bio-oil with the aliphatic phenolic resin precursor and the phenolic resin catalyst may include reacting the phenol-formaldehyde precursor with urea to form the phenolic resin as a phenol-formaldehyde-urea resin.

In some embodiments, the method for preparing the phenolic resin may further include heating the phenolic resin to at least partly cure the phenolic resin. The method may also include heating and extruding the phenolic resin to at least partly cure the phenolic resin in the form of a cured, extruded phenolic resin article.

In various embodiments, a phenolic resin is provided. The phenolic resin may include a plurality of cross-linked phenols. At least a portion of the cross-linked phenols may be derived from a bio-oil and/or a bio-oil polyol.

In various embodiments of the phenolic resin, the bio-oil may include a bio-oil polyol. The bio-oil may include an alkoxylated bio-oil polyol. The alkoxylated bio-oil polyol may be produced by any method described herein.

In some embodiments of the phenolic resin, the at least a portion of the cross-linked phenols derived from the bio-oil may be cross-linked at least in part by formaldehyde such that the phenolic resin may include a phenol-formaldehyde resin. Additionally or alternatively, the at least a portion of the cross-linked phenols derived from the bio-oil may be cross-linked at least in part by a formaldehyde-urea resin such that the phenolic resin may include a phenol-formaldehyde-urea resin.

In several embodiments of the phenolic resin, the bio-oil may be characterized prior to forming the phenolic resin by an amount of free hydroxyls per gram. For example, at least about 10% of the free hydroxyls per gram may be phenol hydroxyls. In another example, at least about 40% of the free hydroxyls per gram may be phenol hydroxyls. In a further example, at least about 50% of the free hydroxyls per gram may be phenol hydroxyls.

In some embodiments of the phenolic resin, the bio-oil may be prepared by catalytic pyrolysis of biomass.

In various embodiments, a phenolic resin article is provided. The phenolic resin article may include a plurality of cross-linked phenols. At least a portion of the cross-linked phenols may be derived from a bio-oil or a bio-oil polyol.

In various embodiments of the phenolic resin article, the bio-oil may include a bio-oil polyol. The bio-oil may include an alkoxylated bio-oil polyol. The alkoxylated bio-oil polyol may be produced by any method described herein.

In some embodiments of the phenolic resin article, the at least a portion of the cross-linked phenols derived from the bio-oil may be cross-linked at least in part by formaldehyde such that the phenolic resin may include a phenol-formaldehyde resin. Additionally or alternatively, the at least a portion of the cross-linked phenols derived from the bio-oil may be cross-linked at least in part by a formaldehyde-urea resin such that the phenolic resin may include a phenol-formaldehyde-urea resin.

In several embodiments of the phenolic resin article, the bio-oil may be characterized prior to forming the phenolic resin by an amount of free hydroxyls per gram. At least about 10% of the free hydroxyls per gram may be phenol hydroxyls. In another example, at least about 40% of the free hydroxyls per gram may be phenol hydroxyls. In a further example, at least about 50% of the free hydroxyls per gram may be phenol hydroxyls.

In various embodiments of the phenolic resin article, the bio-oil may be prepared by catalytic pyrolysis of biomass.

In some embodiments of the phenolic resin article, the phenolic resin article may be an extruded phenolic resin article.

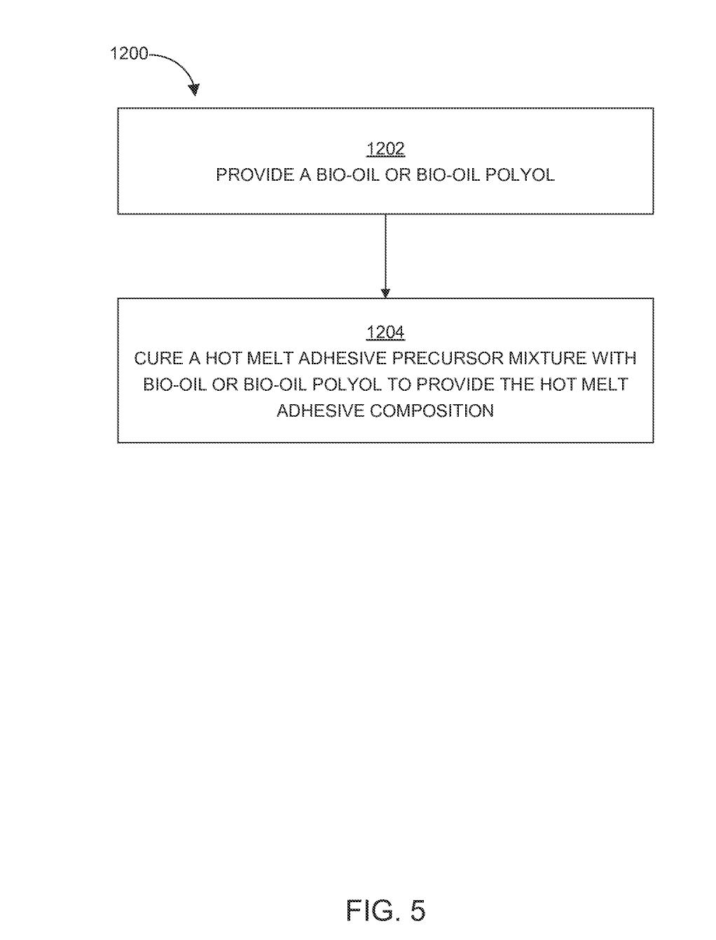

FIG. 5 is a flow diagram of a method 1200 for preparing a hot melt adhesive composition. The method 1200 may include providing an intermediate bio-oil polyol (step 1202). The method 1200 may also include curing a hot melt adhesive precursor mixture with the intermediate bio-oil polyol to provide the hot melt adhesive composition (step 1204).

In various embodiments of the phenolic resin, the intermediate bio-oil polyol may include an alkoxylated bio-oil polyol. The alkoxylated bio-oil polyol may be produced by any method described herein.

In various embodiments, the intermediate bio-oil polyol may be prepared by a process. The process may include reacting a catalytic bio-oil with itself or with a reagent polyol to esterify and/or etherify the catalytic bio-oil to form the intermediate bio-oil polyol.

In some embodiments, the method for preparing the hot melt adhesive composition may include reacting a bio-oil with itself or with a reagent polyol in the presence of an etherification or esterification catalyst to form the intermediate bio-oil polyol.

In several embodiments, the method may also include providing a catalyst to the reaction mixture. The catalyst may contribute to reacting the bio-oil starting material in the reaction mixture to form the polyol bio-oil product. Suitable catalysts may be based on metallic compounds of mercury, lead, tin, bismuth, zinc, and the like. Such metallic compounds may include one or more different oxidation states (I), (II), (III), or (IV), for example, tin(II) and tin(IV) compounds. Such metallic compounds of mercury, lead, tin, bismuth, zinc, and the like, may include metallic carboxylates, oxides, mercaptides, and the like. For example, mercury carboxylates, bismuth carboxylates, zinc carboxylates, tin carboxylates and the like may be suitable catalysts. For example, metal carboxylate compounds may include one or more carboxylates. Such one or more carboxylates may include monocarboxylates, or two or more carboxylates in the same organic carboxylate, such as the dicarboxylate oxalate in tin (II) oxalate. Metal carboxylate compounds may also include alkyl carboxylates with one or more pendant alkyl groups, e.g., dialkyl tin dicarboxylates such as dibutyltin dilaurate. For example, the method may include providing a tin (II) oxalate catalyst to the reaction mixture. The tin (II) oxalate catalyst may contribute to reacting the bio-oil starting material in the reaction mixture to form the polyol bio-oil product.

In various embodiments, the method for preparing the hot melt adhesive composition may include reacting a bio-oil with itself or with a reagent polyol in the presence of a catalyst, e.g., tin(II) oxalate, to form the intermediate bio-oil polyol.

In some embodiments, the hot melt adhesive precursor mixture may include a polycarbonate oligomer or polymer. The hot melt adhesive precursor mixture may include a carboxylate ester of a dihydroquinone. The hot melt adhesive precursor mixture may include a substituted or unsubstituted phenol. The hot melt adhesive precursor mixture may include a lactone diol or a polylactone diol. The hot melt adhesive precursor mixture may include a polyisocyanate. In some embodiments, the hot melt adhesive may include poly(bisphenol A) carbonate, isophthalic acid dihydroquinone ester, 4-phenylphenol, polycaprolactone diol, and 4,4′-methylene bis(phenyl isocyanate).

In several embodiments, a hot melt adhesive composition is provided. The hot melt adhesive composition may be prepared by a process including any subject matter described herein relating to the method for preparing the hot melt adhesive composition.

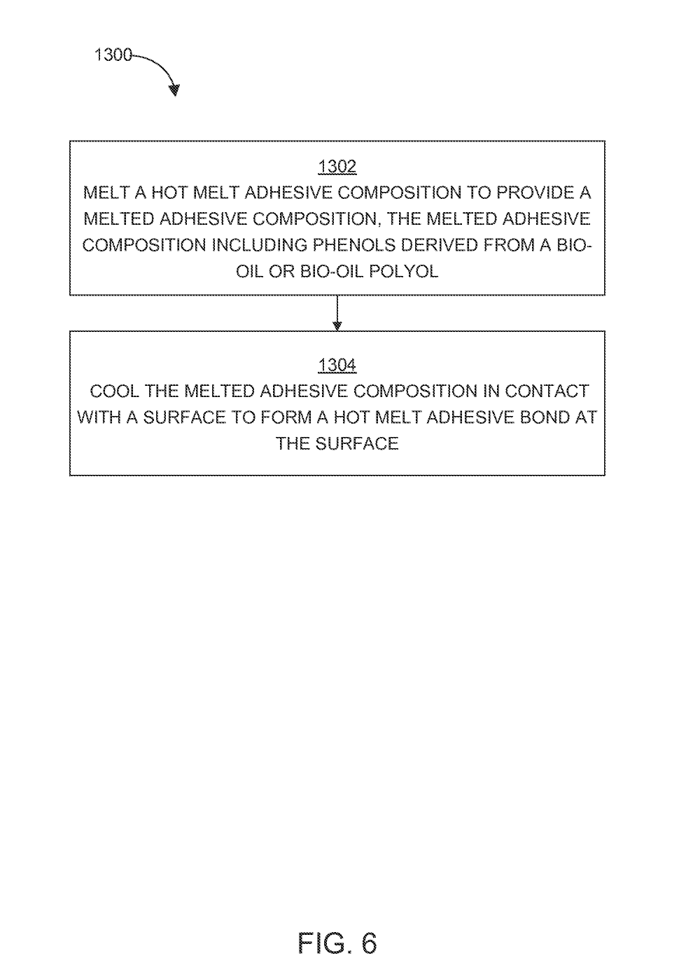

FIG. 6 is a flow diagram of a method 1300 for forming a hot melt adhesive bond. The method 1300 may include melting a hot melt adhesive composition to provide a melted adhesive composition (step 1302). The melted adhesive composition may include phenols derived from a bio-oil or a bio-oil polyol. The method may also include cooling the melted adhesive composition in contact with a surface to form a hot melt adhesive bond at the surface (step 1304). In various embodiments, the hot melt adhesive composition may be prepared by a process including any of the subject matter described herein relating to preparing the hot melt adhesive composition.

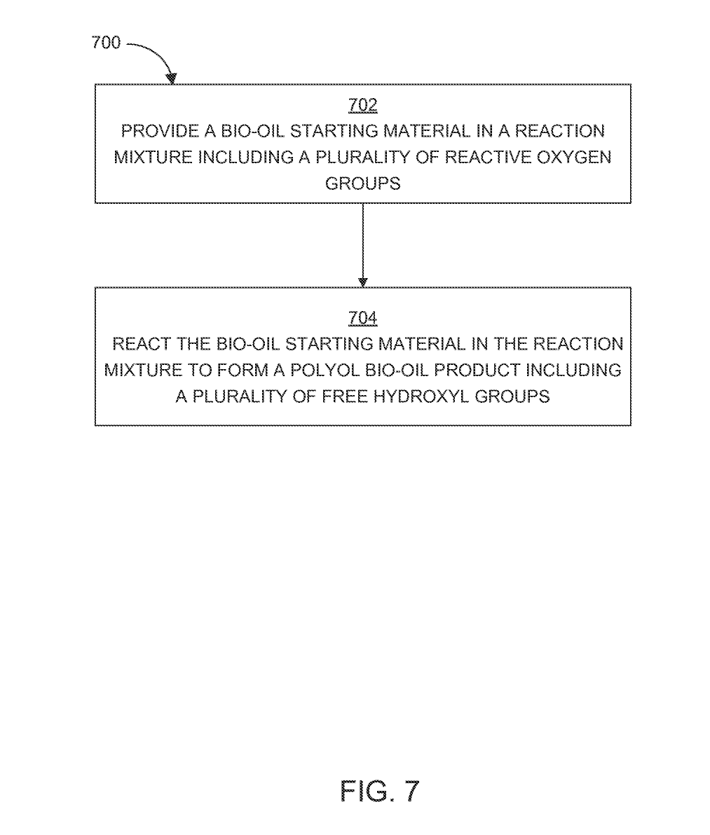

FIG. 7 is a flow diagram of a method 700 of preparing a polyol bio-oil product, according to various embodiments. The method 700 may include 702 providing a bio-oil starting material in a reaction mixture. The reaction mixture may include a plurality of reactive oxygen groups. The bio-oil starting material may include at least a portion of the plurality of reactive oxygen groups. The method may also include 704 reacting the bio-oil starting material in the reaction mixture to form a polyol bio-oil product. The polyol bio-oil product may include a plurality of functional groups that include carbon-oxygen bonds. The carbon-oxygen bonds may be formed by reacting the bio-oil starting material in the reaction mixture. The polyol bio-oil product may include a plurality of free hydroxyl groups.

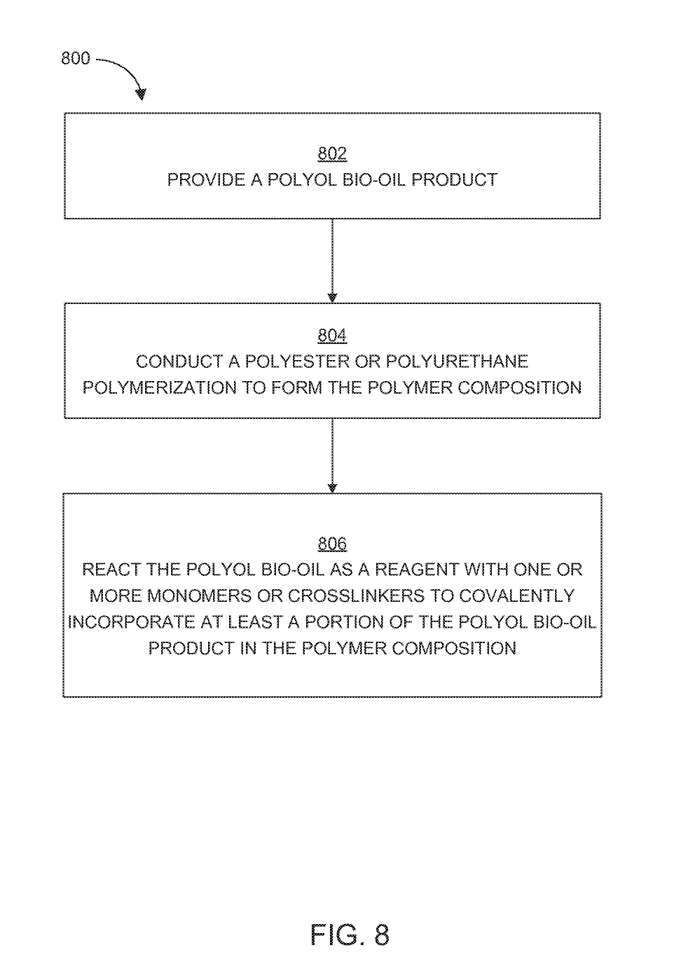

FIG. 8 is a flow diagram of a method 800 for producing a polymer composition using a polyol bio-oil product, according to various embodiments. The method 800 for producing a polymer composition may include 802 providing a polyol bio-oil product. The method for producing a polymer composition may include 804 conducting a polyester or polyurethane polymerization to form the polymer composition. The polyester or polyurethane polymerization may include 806 reacting the polyol bio-oil as a reagent with one or more monomers or crosslinkers. The polymer composition may covalently incorporate at least a portion of the polyol bio-oil product. In various embodiments, the polyol bio-oil product may be provided according to any of the subject matter described herein.

In various embodiments, a method for preparing an alkoxylated bio-oil polyol is provided. The method may include providing a bio-oil polyol. The method may also include reacting the bio-oil polyol with a cyclic alkylene oxide. The bio-oil polyol may be reacted with the cyclic alkylene oxide in the presence of a catalyst. The bio-oil polyol may be reacted with the cyclic alkylene oxide under reaction conditions effective to form the alkoxylated bio-oil polyol.

In some embodiments, the cyclic alkylene oxide may include unsubstituted ethylene oxide. The cyclic alkylene oxide may include ethylene oxide substituted with a linear C₁-C₆ alkyl group. The cyclic alkylene oxide may include ethylene oxide substituted with a branched C₁-C₆ alkyl group. The cyclic alkylene oxide may include ethylene oxide substituted with a C₃-C₆ cycloalkyl group. The cyclic alkylene oxide may include 1,2-propylene oxide. The cyclic alkylene oxide may be present in a weight % compared to a weight of the bio-oil polyol of greater than 10 weight %. The cyclic alkylene oxide may be present in a weight % compared to a weight of the bio-oil polyol of between about 5 weight % and about 70 weight %.

In several embodiments, the reaction conditions may include presence of a catalytic alkali metal hydroxide. The reaction conditions may include presence of a catalytic alkali earth metal hydroxide. The reaction conditions may include presence of a catalytic alkali earth metal oxide. The reaction conditions may include presence of a catalytic amount of potassium hydroxide. The reaction conditions may include presence of an acidified lignin. The reaction conditions may include presence of a catalyst in a weight % compared to a weight of the bio-oil polyol of between about 0.01 weight % and about 5 weight %. The reaction conditions may include a temperature between about 80° C. and about 180° C. The reaction conditions may include a pressure in pounds per square inch of between about 0 and about 600.

In various embodiments, the bio-oil and the bio-oil may be provided together, e.g., the bio-oil polyol may include the bio-oil or the bio-oil may include the bio-oil. The bio-oil polyol may include an intermediate bio-oil polyol derived from the bio-oil modified by reaction with the bio-oil. The bio-oil polyol may include the intermediate bio-oil polyol derived from the bio-oil modified by reaction with a reagent polyol. The bio-oil polyol may include one or more of the bio-oil, the intermediate bio-oil polyol derived from the bio-oil modified by reaction with the bio-oil, or the intermediate bio-oil polyol derived from the bio-oil modified by reaction with the reagent polyol.

In some embodiments, the bio-oil may be or may include a pyrolytic bio-oil produced by pyrolysis of biomass. The bio-oil may be or include a catalytic bio-oil produced by catalytic pyrolysis of biomass. The method may include pyrolyzing biomass to provide the bio-oil. The method may include catalytically pyrolyzing biomass to provide the bio-oil as a catalytic bio-oil. The method may include reacting a bio-oil with the bio-oil to provide the bio-oil polyol. The method may include reacting the bio-oil with the reagent polyol to provide the bio-oil polyol. The method may include reacting the bio-oil with at least one of the bio-oil or a reagent polyol. The method may include reacting the bio-oil with at least one of the bio-oil or a reagent polyol in the presence of a polyol-forming catalyst to provide the bio-oil polyol. The polyol-forming catalyst may include tin.

In several embodiments, the reagent polyol may include one or more of glycerol, ethylene glycol, propylene glycol (1,2-propane diol), 1,3-propanediol, 2-methyl-1,3-propanediol, pentaerythritol, a sugar alcohol, an alcohol amine, a polyalkylene glycol, acidified and/or demethylated crude glycerol, or wet crude glycerol from steam splitting. The reagent polyol may include glycerol. The reagent polyol may include ethylene glycol. The reagent polyol may include 1,3-propanediol. The reagent polyol may include 2-methyl-1,3-propanediol. The reagent polyol may include pentaerythritol. The reagent polyol may include a sugar alcohol. The reagent polyol may include an alcohol amine. The reagent polyol may include a polyalkylene glycol. The reagent polyol may include acidified crude glycerol. The reagent polyol may include demethylated crude glycerol. The reagent polyol may include acidified and demethylated crude glycerol. The reagent polyol may include wet crude glycerol from steam splitting.

In some embodiments, the method may include contacting an acidified lignin to one or more of the bio-oil, the reagent polyol, or the polyol-forming catalyst. The method may include contacting the acidified lignin to the bio-oil. The method may include contacting the acidified lignin to the reagent polyol. The method may include contacting the acidified lignin to the polyol-forming catalyst.

In various embodiments, a method for producing a copolymer composition is provided. The method may include providing a polymerization precursor mixture configured to form a polymer in combination with a reagent polyol, e.g., an alkoxylated bio-oil polyol. The method may also include reacting the alkoxylated bio-oil polyol with the polymerization precursor mixture. The method may be conducted under reaction conditions effective to form the copolymer composition. The alkoxylated bio-oil polyol may be formed according to any method described herein. The method for producing a copolymer composition may include forming the alkoxylated bio-oil polyol according to any method described herein.

In some embodiments, the method may include contacting a viscosity-reducing modifier to the alkoxylated bio-oil polyol and/or the polymerization precursor mixture. The method may include contacting the viscosity-reducing modifier to the alkoxylated bio-oil polyol. The method may include contacting the viscosity-reducing modifier to the polymerization precursor mixture.

In several embodiments, the polymerization precursor mixture may include a polyurethane precursor. The polyurethane precursor may be effective to form the copolymer composition including a copolymer of a polyurethane and the alkoxylated bio-oil polyol. The polyurethane precursor may include one or more of toluene diisocyanate, methylene diphenyl diisocyanate, 1,6-hexamethylene diisocyanate, 1-isocyanato-3-isocyanatomethyl-3,5,5-trimethyl-cyclohexane, or 4,4′-diisocyanato dicyclohexylmethane. The polyurethane precursor may include toluene diisocyanate. The polyurethane precursor may include methylene diphenyl diisocyanate. The polyurethane precursor may include 1,6-hexamethylene diisocyanate. The polyurethane precursor may include 1-isocyanato-3-isocyanatomethyl-3,5,5-trimethyl-cyclohexane. The polyurethane precursor may include 4,4′-diisocyanato dicyclohexylmethane.

In various embodiments, the polymerization precursor mixture may include water. The polymerization precursor mixture may include a petroleum polyol. The polymerization precursor mixture may include the petroleum polyol in a weight % compared to the alkoxylated bio-oil polyol of between about 5 weight % and about 95 weight %. The polymerization precursor mixture may include a surfactant configured to support polyurethane foam formation. The polymerization precursor mixture may include a polyamino alkane configured to catalyze polyurethane formation. The polymerization precursor mixture may include a polyalkylamino alkyl ether configured to catalyze polyurethane formation. The polymerization precursor mixture may include an amino alcohol configured to catalyze polyurethane formation. The polymerization precursor mixture may include a bio-based polyester polyol. The polymerization precursor mixture may include one or more of: a petroleum polyol, water, a silicone foam forming surfactant, a trialkylamine in an alkylene glycol, a polyalkylamino alkyl ether in an alkylene glycol, an antioxidant, a flame retardant, an ultraviolet light stabilizer, a pigment, a dye, or a plasticizer. The polymerization precursor mixture may include the petroleum polyol. The polymerization precursor mixture may include water. The polymerization precursor mixture may include the silicone foam forming surfactant. The polymerization precursor mixture may include the trialkylamine in the alkylene glycol. The polymerization precursor mixture may include the polyalkylamino alkyl ether in the alkylene glycol. The polymerization precursor mixture may include the antioxidant. The polymerization precursor mixture may include the flame retardant. The polymerization precursor mixture may include the ultraviolet light stabilizer. The polymerization precursor mixture may include the pigment. The polymerization precursor mixture may include the dye. The polymerization precursor mixture may include the plasticizer.

In some embodiments, the polymerization precursor mixture may include a polyfunctional ester precursor. The polyfunctional ester precursor may be effective to form the copolymer composition including a copolymer of a polyester and the alkoxylated bio-oil polyol. The polyfunctional ester precursor may include one or more of a polycarboxylic acid, a polyacyl halide, or a cyclic anhydride. The polyfunctional ester precursor may include the polycarboxylic acid. The polyfunctional ester precursor may include the polyacyl halide. The polyfunctional ester precursor may include the cyclic anhydride.

In several embodiments, the reaction conditions may include presence of a catalyst. The reaction conditions may include a temperature between about 0° C. and about 180° C. The reaction conditions may include a pressure in pounds per square inch of between about 15 and about 600.

In various embodiments, the method may include configuring the copolymer composition as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, or an integral skin foam. The method may include configuring the copolymer composition as the foam. The method may include configuring the copolymer composition as the spray foam. The method may include configuring the copolymer composition as the extrusion. The method may include configuring the copolymer composition as the injection molding. The method may include configuring the copolymer composition as the coating. The method may include configuring the copolymer composition as the adhesive. The method may include configuring the copolymer composition as the elastomer. The method may include configuring the copolymer composition as the foundry resin. The method may include configuring the copolymer composition as the sealant. The method may include configuring the copolymer composition as the casting. The method may include configuring the copolymer composition as the fiber. The method may include configuring the copolymer composition as the potting compound. The method may include configuring the copolymer composition as the reaction injection molded (RIM) plastic. The method may include configuring the copolymer composition as the microcellular elastomer or foam. The method may include configuring the copolymer composition as the integral skin foam.

In some embodiments, the polymerization precursor mixture may include an aliphatic phenolic resin precursor and a phenolic resin catalyst effective to produce the copolymer composition as a phenolic resin. The aliphatic phenolic resin precursor may include one or more of a reactive carbonyl compound, a urea derivative, or a formaldehyde-urea resin. The aliphatic phenolic resin precursor may include the reactive carbonyl compound. The aliphatic phenolic resin precursor may include the urea derivative. The aliphatic phenolic resin precursor may include the formaldehyde-urea resin. The aliphatic phenolic resin precursor may include one or more of formaldehyde, acetaldehyde, propionaldehyde, butyraldehyde, glyoxal, propane-1,3-dial, butane-1,4-dial, glutaraldehyde, acetone, 2-butanone, 2-pentanone, 3-pentanone, butane-2,3-dione, or pentane-2,4-dione. The aliphatic phenolic resin precursor may include formaldehyde. The aliphatic phenolic resin precursor may include acetaldehyde. The aliphatic phenolic resin precursor may include propionaldehyde. The aliphatic phenolic resin precursor may include butyraldehyde. The aliphatic phenolic resin precursor may include glyoxal. The aliphatic phenolic resin precursor may include propane-1,3-dial. The aliphatic phenolic resin precursor may include butane-1,4-dial. The aliphatic phenolic resin precursor may include glutaraldehyde. The aliphatic phenolic resin precursor may include acetone. The aliphatic phenolic resin precursor may include 2-butanone. The aliphatic phenolic resin precursor may include 2-pentanone. The aliphatic phenolic resin precursor may include 3-pentanone. The aliphatic phenolic resin precursor may include butane-2,3-dione. The aliphatic phenolic resin precursor may include pentane-2,4-dione. The aliphatic phenolic resin precursor may include a reactive carbonyl compound that is at least partly water soluble.

In various embodiments, a copolymer composition is provided. The copolymer composition may include a copolymerized alkoxylated bio-oil polyol. The copolymer composition may at least in part incorporate a polyester copolymerized with the alkoxylated bio-oil polyol. The polyester may be incorporated as one or more of a covalently polymerized polyester monomer, crosslinker, oligomer, polymer, or copolymer. The polyester may be incorporated as the covalently polymerized polyester monomer. The polyester may be incorporated as the crosslinker. The polyester may be incorporated as the oligomer. The polyester may be incorporated as the polymer. The polyester may be incorporated as the copolymer. The copolymer may at least in part incorporate a polyurethane copolymerized with the alkoxylated bio-oil polyol. The polyurethane may be incorporated as one or more of a covalently polymerized polyurethane monomer, crosslinker, oligomer, polymer, or copolymer. The polyurethane may be incorporated as the covalently polymerized polyurethane monomer. The polyurethane may be incorporated as the crosslinker. The polyurethane may be incorporated as the oligomer. The polyurethane may be incorporated as the polymer. The polyurethane may be incorporated as the copolymer. The alkoxylated bio-oil polyol may be any alkoxylated bio-oil polyol described herein. The alkoxylated bio-oil polyol may be produced according to any method described herein. The copolymer composition may be produced according to any method described herein.

In some embodiments, the copolymer composition may be configured as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, or an integral skin foam. The copolymer composition may be configured as the foam. The copolymer composition may be configured as the spray foam. The copolymer composition may be configured as the extrusion. The copolymer composition may be configured as the injection molding. The copolymer composition may be configured as the coating. The copolymer composition may be configured as the adhesive. The copolymer composition may be configured as the elastomer. The copolymer composition may be configured as the foundry resin. The copolymer composition may be configured as the sealant. The copolymer composition may be configured as the casting. The copolymer composition may be configured as the fiber. The copolymer composition may be configured as the potting compound. The copolymer composition may be configured as the reaction injection molded (RIM) plastic. The copolymer composition may be configured as the microcellular elastomer or foam. The copolymer composition may be configured as the integral skin foam.

In several embodiments, the copolymer composition may at least in part include a reaction product of the alkoxylated bio-oil polyol copolymerized with an aliphatic phenolic resin precursor and a phenolic resin catalyst effective to produce the copolymer composition as a phenolic resin. The aliphatic phenolic resin precursor may include one or more of a reactive carbonyl compound, a urea derivative, or a formaldehyde-urea resin. The aliphatic phenolic resin precursor may include the reactive carbonyl compound. The aliphatic phenolic resin precursor may include the urea derivative. The aliphatic phenolic resin precursor may include the formaldehyde-urea resin. The aliphatic phenolic resin precursor may include one or more of formaldehyde, acetaldehyde, propionaldehyde, butyraldehyde, glyoxal, propane-1,3-dial, butane-1,4-dial, glutaraldehyde, acetone, 2-butanone, 2-pentanone, 3-pentanone, butane-2,3-dione, or pentane-2,4-dione. The aliphatic phenolic resin precursor may include formaldehyde. The aliphatic phenolic resin precursor may include acetaldehyde. The aliphatic phenolic resin precursor may include propionaldehyde. The aliphatic phenolic resin precursor may include butyraldehyde. The aliphatic phenolic resin precursor may include glyoxal. The aliphatic phenolic resin precursor may include propane-1,3-dial. The aliphatic phenolic resin precursor may include butane-1,4-dial. The aliphatic phenolic resin precursor may include glutaraldehyde. The aliphatic phenolic resin precursor may include acetone. The aliphatic phenolic resin precursor may include 2-butanone. The aliphatic phenolic resin precursor may include 2-pentanone. The aliphatic phenolic resin precursor may include 3-pentanone. The aliphatic phenolic resin precursor may include butane-2,3-dione. The aliphatic phenolic resin precursor may include pentane-2,4-dione. The aliphatic phenolic resin precursor may include a reactive carbonyl compound that is at least partly water soluble.

In various embodiments, a copolymer article is provided. The copolymer article may include a copolymer composition including a copolymerized alkoxylated bio-oil polyol. The copolymer composition may be any copolymer composition described herein. The copolymer composition may be produced according to any method described herein. In some embodiments, the copolymer composition may be configured as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, or an integral skin foam. The copolymer composition may be configured as the foam. The copolymer composition may be configured as the spray foam. The copolymer composition may be configured as the extrusion. The copolymer composition may be configured as the injection molding. The copolymer composition may be configured as the coating. The copolymer composition may be configured as the adhesive. The copolymer composition may be configured as the elastomer. The copolymer composition may be configured as the foundry resin. The copolymer composition may be configured as the sealant. The copolymer composition may be configured as the casting. The copolymer composition may be configured as the fiber. The copolymer composition may be configured as the potting compound. The copolymer composition may be configured as the reaction injection molded (RIM) plastic. The copolymer composition may be configured as the microcellular elastomer or foam. The copolymer composition may be configured as the integral skin foam.

In several embodiments, the copolymer composition of the copolymer article may at least in part include a reaction product of the alkoxylated bio-oil polyol copolymerized with an aliphatic phenolic resin precursor and a phenolic resin catalyst effective to produce the copolymer composition as a phenolic resin. The aliphatic phenolic resin precursor may include one or more of a reactive carbonyl compound, a urea derivative, or a formaldehyde-urea resin. The aliphatic phenolic resin precursor may include the reactive carbonyl compound. The aliphatic phenolic resin precursor may include the urea derivative. The aliphatic phenolic resin precursor may include the formaldehyde-urea resin. The aliphatic phenolic resin precursor may include one or more of formaldehyde, acetaldehyde, propionaldehyde, butyraldehyde, glyoxal, propane-1,3-dial, butane-1,4-dial, glutaraldehyde, acetone, 2-butanone, 2-pentanone, 3-pentanone, butane-2,3-dione, or pentane-2,4-dione. The aliphatic phenolic resin precursor may include formaldehyde. The aliphatic phenolic resin precursor may include acetaldehyde. The aliphatic phenolic resin precursor may include propionaldehyde. The aliphatic phenolic resin precursor may include butyraldehyde. The aliphatic phenolic resin precursor may include glyoxal. The aliphatic phenolic resin precursor may include propane-1,3-dial. The aliphatic phenolic resin precursor may include butane-1,4-dial. The aliphatic phenolic resin precursor may include glutaraldehyde. The aliphatic phenolic resin precursor may include acetone. The aliphatic phenolic resin precursor may include 2-butanone. The aliphatic phenolic resin precursor may include 2-pentanone. The aliphatic phenolic resin precursor may include 3-pentanone. The aliphatic phenolic resin precursor may include butane-2,3-dione. The aliphatic phenolic resin precursor may include pentane-2,4-dione. The aliphatic phenolic resin precursor may include a reactive carbonyl compound that is at least partly water soluble.

In various embodiments, a method for preparing a phenolic resin is provided. The method may include providing a bio-oil and/or a bio-oil polyol. The method may include reacting the bio-oil and/or the bio-oil polyol with an aliphatic phenolic resin precursor and a phenolic resin catalyst to form the phenolic resin. The bio-oil and/or the bio-oil polyol may be characterized by an amount of free hydroxyls per gram, at least about 10% of the free hydroxyls per gram being phenol hydroxyls. The bio-oil may be characterized by an amount of free hydroxyls per gram. At least about 40% of the free hydroxyls per gram may be phenol hydroxyls.

In various embodiments, the aliphatic phenolic resin precursor may include one or more of a reactive carbonyl derivative, a urea derivative, or a formaldehyde-urea resin. The aliphatic phenolic resin precursor may include the reactive carbonyl derivative. The aliphatic phenolic resin precursor may include the urea derivative. The aliphatic phenolic resin precursor may include the formaldehyde-urea resin. The aliphatic phenolic resin precursor may include one or more of formaldehyde, urea, or a formaldehyde-urea resin. The aliphatic phenolic resin precursor may include the formaldehyde. The aliphatic phenolic resin precursor may include the urea. The aliphatic phenolic resin precursor may include the formaldehyde-urea resin. The aliphatic phenolic resin precursor may include one or more of a reactive carbonyl compound, a urea derivative, or a formaldehyde-urea resin. The aliphatic phenolic resin precursor may include the reactive carbonyl compound. The aliphatic phenolic resin precursor may include the urea derivative. The aliphatic phenolic resin precursor may include the formaldehyde-urea resin. The aliphatic phenolic resin precursor may include one or more of formaldehyde, acetaldehyde, propionaldehyde, butyraldehyde, glyoxal, propane-1,3-dial, butane-1,4-dial, glutaraldehyde, acetone, 2-butanone, 2-pentanone, 3-pentanone, butane-2,3-dione, or pentane-2,4-dione. The aliphatic phenolic resin precursor may include formaldehyde. The aliphatic phenolic resin precursor may include acetaldehyde. The aliphatic phenolic resin precursor may include propionaldehyde. The aliphatic phenolic resin precursor may include butyraldehyde. The aliphatic phenolic resin precursor may include glyoxal. The aliphatic phenolic resin precursor may include propane-1,3-dial. The aliphatic phenolic resin precursor may include butane-1,4-dial. The aliphatic phenolic resin precursor may include glutaraldehyde. The aliphatic phenolic resin precursor may include acetone. The aliphatic phenolic resin precursor may include 2-butanone. The aliphatic phenolic resin precursor may include 2-pentanone. The aliphatic phenolic resin precursor may include 3-pentanone. The aliphatic phenolic resin precursor may include butane-2,3-dione. The aliphatic phenolic resin precursor may include pentane-2,4-dione. The aliphatic phenolic resin precursor may include a reactive carbonyl compound that is at least partly water soluble.

In some embodiments, the phenolic resin catalyst may be configured to catalyze formation of one or more of a phenol-formaldehyde resin, a formaldehyde-urea resin, or a phenol-formaldehyde-urea resin. The phenolic resin catalyst may be configured to catalyze formation of the phenol-formaldehyde resin. The phenolic resin catalyst may be configured to catalyze formation of the formaldehyde-urea resin. The phenolic resin catalyst may be configured to catalyze formation of the phenol-formaldehyde-urea resin.

In several embodiments, the phenolic resin catalyst may include one of an acid catalyst or a basic catalyst. The phenolic resin catalyst may include the acid catalyst. The phenolic resin catalyst may include the basic catalyst. The phenolic resin catalyst may include one or more of: a carboxylic acid, a carboxylate salt, hydrochloric acid, a sulfonate acid, ammonia, an amine, an amide, an alkylamine, pyridine, an alkali metal hydroxide, an alkali earth metal hydroxide, or an alkali earth metal oxide. The phenolic resin catalyst may include the carboxylic acid. The phenolic resin catalyst may include the carboxylate salt. The phenolic resin catalyst may include the hydrochloric acid. The phenolic resin catalyst may include the a sulfonate acid. The phenolic resin catalyst may include the ammonia. The phenolic resin catalyst may include the amine. The phenolic resin catalyst may include the amide. The phenolic resin catalyst may include the alkylamine. The phenolic resin catalyst may include the pyridine. The phenolic resin catalyst may include the alkali metal hydroxide. The phenolic resin catalyst may include the alkali earth metal hydroxide. The phenolic resin catalyst may include the alkali earth metal oxide.

In several embodiments, the bio-oil may be or may include a pyrolytic bio-oil prepared by pyrolysis of biomass. The bio-oil may be or may include a catalytic bio-oil prepared by catalytic pyrolysis of biomass. The reacting the bio-oil and/or the bio-oil polyol with the aliphatic phenolic resin precursor and the phenolic resin catalyst may include reacting the bio-oil and/or the bio-oil polyol with formaldehyde to form the phenolic resin as a phenol-formaldehyde resin. The reacting the bio-oil and/or the bio-oil polyol with the aliphatic phenolic resin precursor and the phenolic resin catalyst may include reacting the bio-oil and/or the bio-oil polyol with formaldehyde-urea to form the phenolic resin as a phenol-formaldehyde-urea resin. The reacting the bio-oil and/or the bio-oil polyol with the aliphatic phenolic resin precursor and the phenolic resin catalyst may include reacting the bio-oil and/or the bio-oil polyol with formaldehyde to form a phenol-formaldehyde precursor, and reacting the phenol-formaldehyde precursor with urea to form the phenolic resin as a phenol-formaldehyde-urea resin.

In various embodiments, the method may include heating the phenolic resin to at least partly cure the phenolic resin. The method may include heating and extruding the phenolic resin to at least partly cure the phenolic resin in the form of a cured, extruded phenolic resin article.

In some embodiments, the bio-oil may include the bio-oil polyol. The bio-oil may include an intermediate bio-oil polyol. The intermediate bio-oil polyol may include the bio-oil modified by reaction with the bio-oil. The intermediate bio-oil polyol may include the bio-oil modified by reaction with a reagent polyol. The bio-oil may include an alkoxylated bio-oil polyol. The method may include the alkoxylated bio-oil polyol according to any description herein. The method may include producing the alkoxylated bio-oil polyol according to any method described herein.

In various embodiments, a phenolic resin is provided. The phenolic resin may be formed as a phenolic resin article. The phenolic resin may include a plurality of cross-linked phenols. At least a portion of the cross-linked phenols may be derived from a bio-oil and/or a bio-oil polyol. The at least a portion of the cross-linked phenols derived from the bio-oil and/or the bio-oil polyol may be cross-linked at least in part by formaldehyde such that the phenolic resin includes a phenol-formaldehyde resin. The at least a portion of the cross-linked phenols derived from the bio-oil and/or the bio-oil polyol may be cross-linked at least in part by a formaldehyde-urea resin such that the phenolic resin includes a phenol-formaldehyde-urea resin. The bio-oil and/or the bio-oil polyol may be characterized prior to forming the phenolic resin by an amount of free hydroxyls per gram. At least about 10% of the free hydroxyls per gram may be phenol hydroxyls. At least about 40% of the free hydroxyls per gram may be phenol hydroxyls. The bio-oil may be prepared by pyrolysis of biomass or catalytic pyrolysis of biomass. The bio-oil polyol may include any intermediate bio-oil polyol described herein. The bio-oil polyol may include any alkoxylated bio-oil polyol described herein. The alkoxylated bio-oil polyol may be produced by any method described herein.

In some embodiments, the at least a portion of the cross-linked phenols derived from the bio-oil and/or the bio-oil polyol may be cross-linked at least in part by an aliphatic phenolic resin precursor. the aliphatic phenolic resin precursor may include one or more of a reactive carbonyl derivative, a urea derivative, or a formaldehyde-urea resin. The aliphatic phenolic resin precursor may include the reactive carbonyl derivative. The aliphatic phenolic resin precursor may include the urea derivative. The aliphatic phenolic resin precursor may include the formaldehyde-urea resin. The aliphatic phenolic resin precursor may include one or more of formaldehyde, urea, or a formaldehyde-urea resin. The aliphatic phenolic resin precursor may include the formaldehyde. The aliphatic phenolic resin precursor may include the urea. The aliphatic phenolic resin precursor may include the formaldehyde-urea resin. The aliphatic phenolic resin precursor may include one or more of a reactive carbonyl compound, a urea derivative, or a formaldehyde-urea resin. The aliphatic phenolic resin precursor may include the reactive carbonyl compound. The aliphatic phenolic resin precursor may include the urea derivative. The aliphatic phenolic resin precursor may include the formaldehyde-urea resin. The aliphatic phenolic resin precursor may include one or more of formaldehyde, acetaldehyde, propionaldehyde, butyraldehyde, glyoxal, propane-1,3-dial, butane-1,4-dial, glutaraldehyde, acetone, 2-butanone, 2-pentanone, 3-pentanone, butane-2,3-dione, or pentane-2,4-dione. The aliphatic phenolic resin precursor may include formaldehyde. The aliphatic phenolic resin precursor may include acetaldehyde. The aliphatic phenolic resin precursor may include propionaldehyde. The aliphatic phenolic resin precursor may include butyraldehyde. The aliphatic phenolic resin precursor may include glyoxal. The aliphatic phenolic resin precursor may include propane-1,3-dial. The aliphatic phenolic resin precursor may include butane-1,4-dial. The aliphatic phenolic resin precursor may include glutaraldehyde. The aliphatic phenolic resin precursor may include acetone. The aliphatic phenolic resin precursor may include 2-butanone. The aliphatic phenolic resin precursor may include 2-pentanone. The aliphatic phenolic resin precursor may include 3-pentanone. The aliphatic phenolic resin precursor may include butane-2,3-dione. The aliphatic phenolic resin precursor may include pentane-2,4-dione. The aliphatic phenolic resin precursor may include a reactive carbonyl compound that is at least partly water soluble.

In various embodiments, a method for preparing a hot melt adhesive composition is provided. The method may include providing a bio-oil. The method may include providing a bio-oil polyol. The method may include curing a hot melt adhesive precursor mixture with the bio-oil to provide the hot melt adhesive composition. The method may include curing the hot melt adhesive precursor mixture with the bio-oil polyol to provide the hot melt adhesive composition. The bio-oil polyol may include an intermediate bio-oil polyol prepared by a process including reacting a catalytic bio-oil with itself to esterify and/or etherify the catalytic bio-oil to form the intermediate bio-oil polyol. The bio-oil polyol may include an intermediate bio-oil polyol prepared by a process including reacting a catalytic bio-oil with a reagent polyol to esterify and/or etherify the catalytic bio-oil to form the intermediate bio-oil polyol. The method may include reacting the bio-oil with itself in the presence of an etherification or esterification catalyst to form the bio-oil polyol as an intermediate bio-oil polyol. The method may include reacting the bio-oil with a reagent polyol in the presence of an etherification or esterification catalyst to form the bio-oil polyol as an intermediate bio-oil polyol. The catalyst may include tin.

In various embodiments, the hot melt adhesive precursor mixture may include a polycarbonate oligomer. The hot melt adhesive precursor mixture may include a polycarbonate polymer. The hot melt adhesive precursor mixture may include a carboxylate ester of a dihydroquinone. The hot melt adhesive precursor mixture may include a substituted phenol. The hot melt adhesive precursor mixture may include an unsubstituted phenol. The hot melt adhesive precursor mixture may include a lactone diol. The hot melt adhesive precursor mixture may include a polylactone diol. The hot melt adhesive precursor mixture may include a polyisocyanate.

In several embodiments, the hot melt adhesive may include one or more of poly(bisphenol A) carbonate, isophthalic acid dihydroquinone ester, 4-phenylphenol, polycaprolactone diol, and 4,4′-methylene bis(phenyl isocyanate). The hot melt adhesive may include poly(bisphenol A) carbonate. The hot melt adhesive may include isophthalic acid dihydroquinone ester. The hot melt adhesive may include 4-phenylphenol. The hot melt adhesive may include polycaprolactone diol. The hot melt adhesive may include 4,4′-methylene bis(phenyl isocyanate).

In some embodiments, the bio-oil polyol may include an intermediate bio-oil polyol. The bio-oil polyol may include any alkoxylated bio-oil polyol described herein. The alkoxylated bio-oil polyol may be produced according to any method described herein.

In various embodiments, a hot melt adhesive composition is provided. The hot melt adhesive composition may be prepared according to any method described herein.

In several embodiments, a method for forming a hot melt adhesive bond is provided. The method may include melting a hot melt adhesive composition to provide a melted adhesive composition. The melted adhesive composition may include phenols derived from a bio-oil and/or a bio-oil polyol. The method may include cooling the melted adhesive composition in contact with a surface to form a hot melt adhesive bond at the surface. The hot melt adhesive composition may be prepared by any method described herein.

In several embodiments, a method of preparing a polyol bio-oil product is provided. The method may include providing a bio-oil starting material in a reaction mixture. The reaction mixture may include a plurality of reactive oxygen groups. The bio-oil starting material may include at least a portion of the plurality of reactive oxygen groups. The method may also include reacting the bio-oil starting material in the reaction mixture to form a polyol bio-oil product. The polyol bio-oil product may include a plurality of functional groups that include carbon-oxygen bonds. The carbon-oxygen bonds may be formed by reacting the bio-oil starting material in the reaction mixture. The polyol bio-oil product may include a plurality of free hydroxyl groups.

In various embodiments, the plurality of reactive oxygen groups may include one or more of free hydroxyls, carboxylic acids, carbonyls, or cyclic alkylene oxides. At least a portion of the plurality of free hydroxyl groups included by the polyol bio-oil product may be derived from a portion of plurality of free hydroxyl groups included by the bio-oil starting material. At least a portion of the plurality of free hydroxyl groups included by the polyol bio-oil product may be formed by reacting the bio-oil starting material in the reaction mixture to transform at least a portion of the plurality of reactive oxygen groups into the at least a portion of the plurality of free hydroxyl groups included by the polyol bio-oil product.

In some embodiments, the method may also include providing one or more of a reagent polyol or a cyclic alkylene oxide to the reaction mixture. At least a portion of the plurality of reactive oxygen groups may be provided by one or more of the reagent polyol or the cyclic alkylene oxide. Reacting the bio-oil starting material in the reaction mixture to form the polyol bio-oil product may include reacting the bio-oil starting material with one or more of the reagent polyol or the cyclic alkylene oxide.

In several embodiments, the method may also include providing a catalyst to the reaction mixture. The catalyst may contribute to reacting the bio-oil starting material in the reaction mixture to form the polyol bio-oil product. Suitable catalysts may be based on metallic compounds of mercury, lead, tin, bismuth, zinc, or the like. For example, mercury carboxylates, bismuth carboxylates, zinc carboxylates, alkyl tin carboxylates (such as tin (II) oxalate), oxides, and mercaptides, or the like may be suitable catalysts. For example, the method may include providing a tin (II) oxalate catalyst to the reaction mixture. The tin (II) oxalate catalyst may contribute to reacting the bio-oil starting material in the reaction mixture to form the polyol bio-oil product.

In various embodiments, the bio-oil starting material may include at least a portion of the reactive oxygen groups including at least free hydroxyls and free carboxylic acids. Forming the carbon-oxygen bonds may include forming ester bonds between at least a portion of the free hydroxyls and the free carboxylic acids included by the bio-oil starting material.

In some embodiments, the bio-oil starting material may include at least a portion of the reactive oxygen groups including at least free carboxylic acids. The method may also include adding one or more of a reagent polyol or a cyclic alkylene oxide to the reaction mixture. Forming the carbon-oxygen bonds may include forming ester bonds by reacting the free carboxylic acids of the bio-oil starting material with one or more of the reagent polyol or the cyclic alkylene oxide. The added polyol reagent may include one or more of a sugar alcohol, an alkylene glycol, a polyalkylene glycol, and the like. Examples of sugar alcohols and alkylene glycols may include, but are not limited to, glycerol, ethylene glycol, propylene glycol (1,2-propane diol), 1,3-propanediol, 2-methyl-1,3-propanediol, pentaerythritol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, or the like. Examples of polyalkylene glycols may include, but are not limited to, a polyethylene glycol, a polypropylene glycol, or a poly(tetramethylene ether) glycol, or the like.

For example, the added polyol reagent may include one or more of glycerol, ethylene glycol, propylene glycol (1,2-propane diol), 1,3-propanediol, 2-methyl-1,3-propanediol, pentaerythritol, a sugar alcohol, a polyethylene glycol, a polypropylene glycol, or a poly(tetramethylene ether) glycol.

In several embodiments, the added cyclic alkylene oxide may include one or more of ethylene oxide or propylene oxide.

In various embodiments, the method may also include pyrolyzing biomass to provide the bio-oil starting material. Biomass may include, for example, lignin, cellulose, or lignocelluloses or mixtures thereof.

In some embodiments, a polyol bio-oil product for use in forming a polyester or a polyurethane is provided. The polyol bio-oil product may be produced by a process. The process may include providing a bio-oil starting material in a reaction mixture. The reaction mixture may include a plurality of reactive oxygen groups. The bio-oil starting material may include at least a portion of the plurality of reactive oxygen groups. The process may also include reacting the bio-oil starting material in the reaction mixture to form a polyol bio-oil product. The polyol bio-oil product may include a plurality of functional groups including carbon-oxygen bonds formed by reacting the bio-oil starting material in the reaction mixture. The polyol bio-oil product may include a plurality of free hydroxyl groups.

In several embodiments, the plurality of reactive oxygen groups may include one or more of free hydroxyls, carboxylic acids, carbonyls, or cyclic alkylene oxides. At least a portion of the plurality of free hydroxyl groups included by the polyol bio-oil product may be derived from a portion of plurality of free hydroxyl groups included by the bio-oil starting material. At least a portion of the plurality of free hydroxyl groups included by the polyol bio-oil product may be formed by reacting the bio-oil starting material in the reaction mixture to transform at least a portion of the plurality of reactive oxygen groups into the at least a portion of the plurality of free hydroxyl groups included by the polyol bio-oil product.

In various embodiments, the process may also include providing one or more of a reagent polyol or a cyclic alkylene oxide to the reaction mixture. At least a portion of the plurality of reactive oxygen groups may be provided by one or more of the reagent polyol or the cyclic alkylene oxide. Reacting the bio-oil starting material in the reaction mixture to form the polyol bio-oil product may include reacting the bio-oil starting material with one or more of the reagent polyol or the cyclic alkylene oxide.

In some embodiments, the process may also include providing a catalyst to the reaction mixture. The catalyst may contribute to reacting the bio-oil starting material in the reaction mixture to form the polyol bio-oil product. Suitable catalysts may be based on metallic compounds of mercury, lead, tin, bismuth, zinc, or the like. For example, mercury carboxylates, bismuth carboxylates, zinc carboxylates, alkyl tin carboxylates (such as tin (II) oxalate), oxides, and mercaptides, or the like may be suitable catalysts. For example, the method may include providing a tin (II) oxalate catalyst to the reaction mixture. The tin (II) oxalate catalyst may contribute to reacting the bio-oil starting material in the reaction mixture to form the polyol bio-oil product.

In several embodiments, the bio-oil starting material may include at least a portion of the reactive oxygen groups including at least free hydroxyls and free carboxylic acids. Forming the carbon-oxygen bonds may include forming ester bonds between at least a portion of the free hydroxyls and the free carboxylic acids included by the bio-oil starting material.

In various embodiments, the bio-oil starting material may include at least a portion of the reactive oxygen groups including at least free carboxylic acids. The method may also include adding one or more of a reagent polyol or a cyclic alkylene oxide to the reaction mixture. Forming the carbon-oxygen bonds may include forming ester bonds by reacting the free carboxylic acids of the bio-oil starting material with one or more of the reagent polyol or the cyclic alkylene oxide. The added polyol reagent may include one or more of a sugar alcohol, an alkylene glycol, a polyalkylene glycol, and the like. Examples of sugar alcohols and alkylene glycols may include, but are not limited to, glycerol, ethylene glycol, propylene glycol (1,2-propane diol), 1,3-propanediol, 2-methyl-1,3-propanediol, pentaerythritol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, or the like. Examples of polyalkylene glycols may include, but are not limited to, a polyethylene glycol, a polypropylene glycol, or a poly(tetramethylene ether) glycol, or the like.

For example, the added polyol reagent may include one or more of glycerol, ethylene glycol, propylene glycol (1,2-propane diol), 1,3-propanediol, 2-methyl-1,3-propanediol, pentaerythritol, a sugar alcohol, a polyethylene glycol, a polypropylene glycol, or a poly(tetramethylene ether) glycol.

In various embodiments, the added cyclic alkylene oxide may include one or more of ethylene oxide or propylene oxide.

In some embodiments, the process may also include pyrolyzing biomass to provide the bio-oil starting material. Biomass may include, for example, lignin, cellulose, or lignocelluloses or mixtures thereof.

In another embodiment, a polyol bio-oil product for use in forming a polyester or a polyurethane is provided. The polyol bio-oil product may be produced by a process. The process may include providing a bio-oil starting material in a reaction mixture. The reaction mixture may include a plurality of reactive oxygen groups. The bio-oil starting material may include at least a portion of the plurality of reactive oxygen groups. The process may also include reacting the bio-oil starting material in the reaction mixture to form a polyol bio-oil product. The polyol bio-oil product may include a plurality of functional groups including carbon-oxygen bonds formed by reacting the bio-oil starting material in the reaction mixture. The polyol bio-oil product may include a plurality of free hydroxyl groups.

In various embodiments, a method for producing a polymer composition may be provided. The method for producing a polymer composition may include providing a polyol bio-oil product. The method for producing a polymer composition may include conducting a polyester or polyurethane polymerization to form the polymer composition. The polyester or polyurethane polymerization may include reacting the polyol bio-oil as a reagent with one or more monomers or crosslinkers. The polymer composition may covalently incorporate at least a portion of the polyol bio-oil product.

In several embodiments, the one or more monomers or crosslinkers may include at least one of a cyclic alkylene oxide, a polycarboxylate reagent, and a polyol reagent. Reacting the polyol bio-oil product with the one or more monomers or crosslinkers may form the polymer composition including a polyester.

In various embodiments, the method for producing a polymer composition may also include adding a polyester polymerization catalyst. The polyester polymerization catalyst may contribute to reacting the polyol bio-oil product with the one or more monomers or crosslinkers to form the polymer composition. Suitable polyester catalysts may include, for example, antimony trioxide, antimony triacetate, alkali hydroxides such as potassium hydroxide, oligomeric aluminoxane, or the like. Further crosslinking may be obtained with organic peroxide catalysts such as methyl ethyl ketone peroxide, benzoyl peroxide, or the like. Metallic compounds based on mercury, lead, tin, bismuth, and zinc may be suitable as polyester catalysts, e.g., mercury carboxylates, bismuth carboxylates, zinc carboxylates, alkyl tin carboxylates (such as tin (II) oxalate), oxides, and mercaptides, or the like.

In some embodiments, the one or more monomers or crosslinkers may include a polyisocyanate. Reacting the polyol bio-oil product with the one or more monomers or crosslinkers may form the polymer composition including a polyurethane. Suitable polyisocyanates may include, but are not limited to, toluene diisocyanate, methylene diphenyl diisocyanate, 1,6-hexamethylene diisocyanate, 1-isocyanato-3-isocyanatomethyl-3,5,5-trimethyl-cyclohexane, 4,4′-diisocyanato dicyclohexylmethane, or the like.

In several embodiments, the method for producing a polymer composition may also include adding a polyurethane polymerization catalyst for reacting the polyol bio-oil product with one or more monomers or crosslinkers to form the polymer composition. Suitable polyurethane catalysts may include, but are not limited to amine compounds and metal complexes. Suitable amine catalysts may include, but are not limited to, tertiary amines such as triethylenediamine, dimethylcyclohexylamine, dimethylethanolamine, or the like. Metallic compounds based on mercury, lead, tin, bismuth, and zinc may be suitable as polyurethane catalysts, e.g., mercury carboxylates, bismuth carboxylates, zinc carboxylates, alkyl tin carboxylates (such as tin (II) oxalate), oxides, and mercaptides, or the like.

In various embodiments, a polymer composition is provided. The polymer composition may include one or more of a polyester or a polyurethane. The polyester or the polyurethane may covalently incorporate a polyol bio-oil product. In various embodiments, the polyol bio-oil product may be provided according to any of the subject matter described herein. In several embodiments, the polymer composition may be prepared according to any of the subject matter described herein.

In another embodiment, a polymer composition is provided. The polymer composition may include one or more of a polyester or a polyurethane. The polyester or the polyurethane may covalently incorporate a polyol bio-oil product. The polyol bio-oil product may be provided according to any of the subject matter described herein. The polymer composition may be prepared according to any of the subject matter described herein.

### EXAMPLES

### Example 1A

### Modification of Catalytic Bio-Oil Produces Catalytic Intermediate Bio-Oil Polyol

About 1723.3 g (grams) of catalytically-produced bio-oil was reacted with about 181.65 g of glycerol in the presence of about 1.16 g of tin (II) oxalate. The reaction was heated at about 225° C. for 4 hours. The reaction was held for 40 minutes, after which 0.25 standard cubic feet per hour (SCFH) of argon headspace flow was added for 1 hour. The material was poured into a silicone mold, cooled, and broken to result in an intermediate bio-oil polyol as a glassy solid.

### Example 1B

### Alkoxylation of Catalytic Intermediate Bio-Oil Polyol Produces Alkoxylated Catalytic Bio-Oil Polyol

A reaction mixture was formed in an autoclave reactor by combining about 900.17 g of the intermediate bio-oil polyol of EXAMPLE 1A, about 600 g of propylene oxide, and about 10.85 g of potassium hydroxide. The reaction mixture was stirred in the autoclave under about 200 psi of argon for 1 hour. The autoclave reactor was then heated at about 130° C. and a pressure of about 450 psi, and the reaction mixture was stirred for an additional 4 hours. The reaction mixture was cooled to ambient temperature to result in an alkoxylated bio-oil polyol, derived from catalytically-produced bio-oil as a tacky viscous liquid.

### Example 2A

### Modification of Non-Catalytic Bio-Oil Produces Non-Catalytic Intermediate Bio-Oil Polyol

About 1665.50 g of non-catalytically produced bio-oil was reacted with about 183.96 g of glycerol in the presence of about 10.02 g of tin (II) oxalate. The reaction was heated at about 225° C. for about 4 hours. The reaction was held for about 40 minutes, after which 0.25 SCFH of argon headspace flow was added for about 1 hour. The material was poured into a Teflon lined mold and resulted in an intermediate bio-oil polyol that is derived from non-catalytically produced bio-oil. The intermediate bio-oil polyol was a glassy solid.

### Example 2B

### Alkoxylation of Non-Catalytic Intermediate Bio-Oil Polyol Produces Alkoxylated Non-Catalytic Bio-Oil Polyol

A reaction mixture was formed in an autoclave reactor by combining about 1632.40 g of the intermediate bio-oil polyol of EXAMPLE 2A, about 1074.82 g of propylene oxide, and about 13.60 g of potassium hydroxide. The reaction mixture was placed under about 5 psi. The autoclave reactor was heated at about 130° C., stirred, and a pressure of about 160 psi developed over the 4 hours of reaction time. The reaction mixture was cooled to ambient temperature to result in an alkoxylated bio-oil polyol, derived from non-catalytically-produced bio-oil, in the form of a tacky viscous liquid.

### Example 3A

### Formation of Control Foam Using Conventional Petroleum Polyol

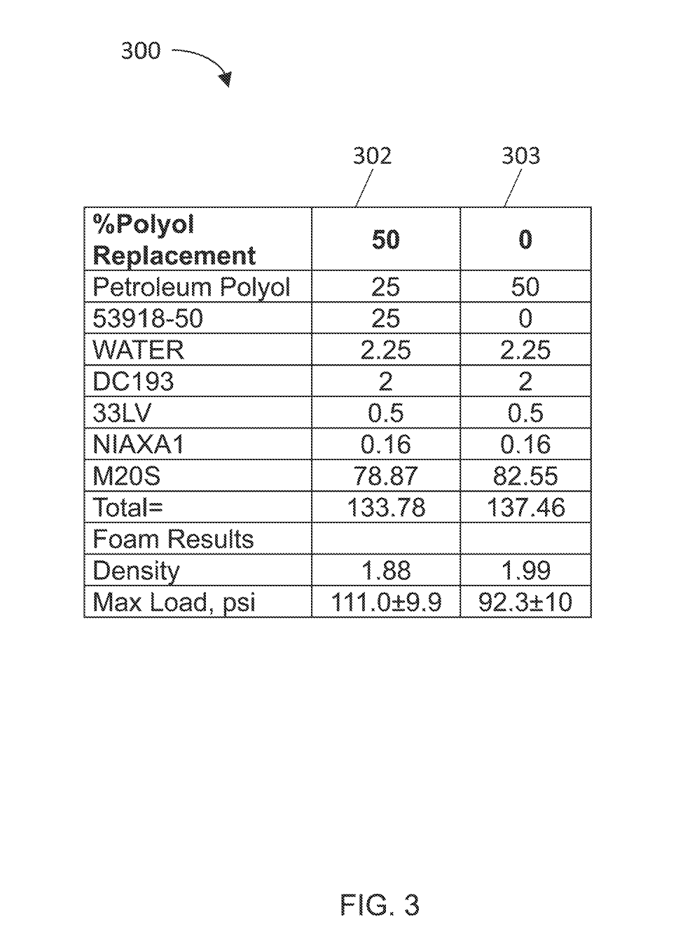

A foamable reaction mixture was formed by combining: about 50 parts of petroleum polyol (JEFFOL® SG 360, Huntsman, Auburn Hills, Mich.), about 2.25 parts of water, about 2 parts of a silicone surfactant (DABCO® DC193, Air Products, Allentown, Pa.; sold as industry standard silicone surfactant for conventional rigid polyurethane foam), about 0.5 parts 33% triethylene diamine in 67% dipropylene glycol (DABCO® 33-LV, Air Products, Allentown, Pa.; a tertiary amine catalyst for promoting urethane (polyol isocyanate) reactions), about 0.16 parts of 70 percent bis(2-dimethylaminoethyl) ether in 30 weight percent dipropylene glycol (Niax* catalyst A-1, Momentive, Columbus Ohio; an active amine catalyst for forming urethane foam), and about 82.55 parts of 4,4′-diphenylmethane diisocyanate containing isomers and oligomers (LUPRANATE® M20S, BASF, Florham Park, N.J., a urethane forming reagent). The components of the reaction mixture were combined at the same time, except for the 4,4′-diphenylmethane diisocyanate, which was added last. The foamable reaction mixture containing 50 parts petroleum polyol was reacted at ambient temperature to form a polyurethane foam composition characterized by a density of 1.99 g/cubic centimeter and a maximum load in psi of 111.0±9.9. See also table 300 in FIG. 3, column 303.

### Example 3B

### Formation of Foam Using Catalytically Derived Alkoxylated Bio-Oil to Replace 50% of Conventional Petroleum Polyol

A foamable reaction mixture was formed using 25 parts of the alkoxylated bio-oil polyol of EXAMPLE 1B, derived from catalytically-produced bio-oil. Also added to the reaction mixture was about 25 parts of parts of the petroleum polyol, about 2.25 parts of water, about 2 parts of the silicone surfactant (DABCO® DC193, Air Products, Allentown, Pa.), about 0.5 parts 33% triethylene diamine in 67% dipropylene glycol (DABCO® 33-LV, Air Products, Allentown, Pa.), about 0.16 parts of 70 percent bis(2-dimethylaminoethyl) ether in 30 weight percent dipropylene glycol (Niax* catalyst A-1, Momentive, Columbus Ohio), and about 78.87 parts of 4,4′-diphenylmethane diisocyanate containing isomers and oligomers (LUPRANATE® M205, BASF, Florham Park, N.J.). The components of the reaction mixture were combined at the same time, except for the 4,4′-diphenylmethane diisocyanate, which was added last. The mixture was reacted at ambient temperature to form a polyurethane foam composition characterized by a density of 1.88 g/cubic centimeter and a maximum load in psi of 111.0±9.9. See also table 300 in FIG. 3, column 302. Compared to EXAMPLE 3A, the present example represents replacement of about 50% of the petroleum polyol with the alkoxylated bio-oil polyol of EXAMPLE 1B, derived from catalytically-produced bio-oil.

### Example 3C

### Foam Formed Using Non-Catalytically Derived Alkoxylated Bio-Oil to Replace 50% of Conventional Petroleum Polyol

A foamable reaction mixture was formed using 25 parts of the alkoxylated bio-oil polyol of EXAMPLE 2B, derived from catalytically-produced bio-oil. Also added to the reaction mixture was about 25 parts of parts of a petroleum polyol, about 2.25 parts of water, about 2 parts of the silicone surfactant (DABCO® DC193, Air Products, Allentown, Pa.), about 0.5 parts 33% triethylene diamine in 67% dipropylene glycol (DABCO® 33-LV, Air Products, Allentown, Pa.), about 0.16 parts of 70 percent bis(2-dimethylaminoethyl) ether in 30 weight percent dipropylene glycol (Niax* catalyst A-1, Momentive, Columbus Ohio), and about 78.87 parts of 4,4′-diphenylmethane diisocyanate containing isomers and oligomers (LUPRANATE® M20S, BASF, Florham Park, N.J.). The components of the reaction mixture were combined at the same time, except for the 4,4′-diphenylmethane diisocyanate, which was added last. The mixture was reacted at ambient temperature to form a polyurethane foam composition characterized by a density of 2.13 g/cubic centimeter and a maximum load in psi of 134.0±16.4. See also table 300 in FIG. 3, column 302. Compared to EXAMPLE 3A, the present example represents replacement of about 50% of the petroleum polyol with the alkoxylated bio-oil polyol of EXAMPLE 1B, derived from non-catalytically-produced bio-oil.

### Example 4A

### Modification of Catalytic Bio-Oil Produces Catalytic Intermediate Bio-Oil Polyol; Alkoxylation Produces Alkoxylated Catalytic Bio-Oil Polyol

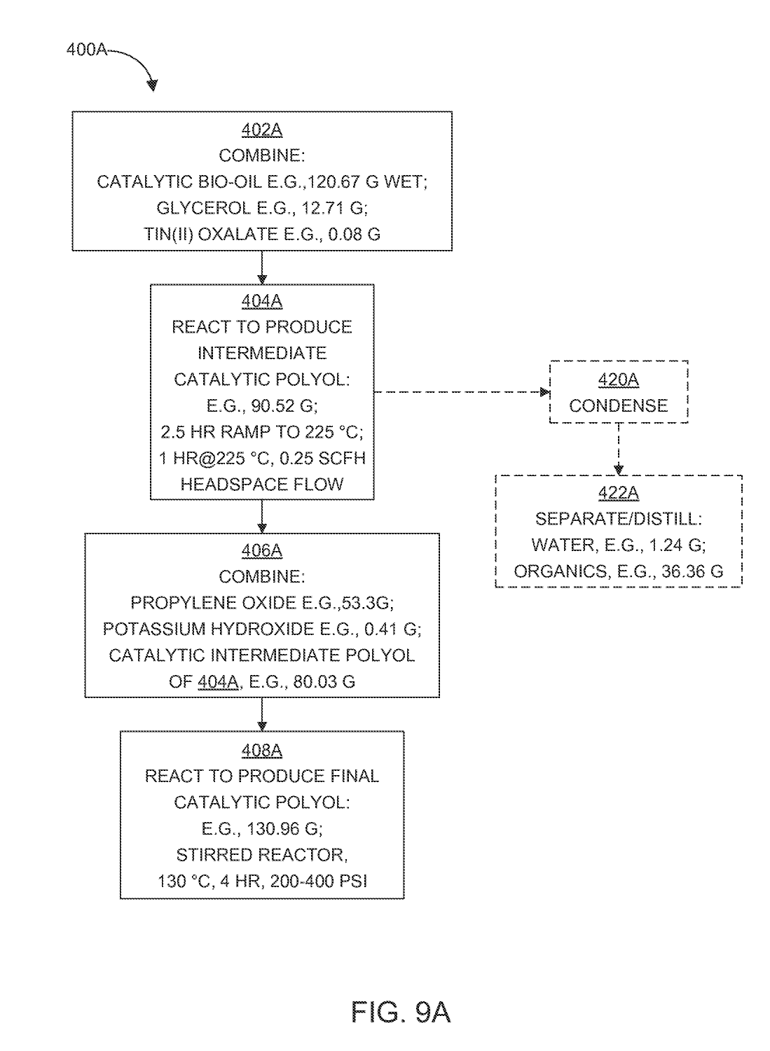

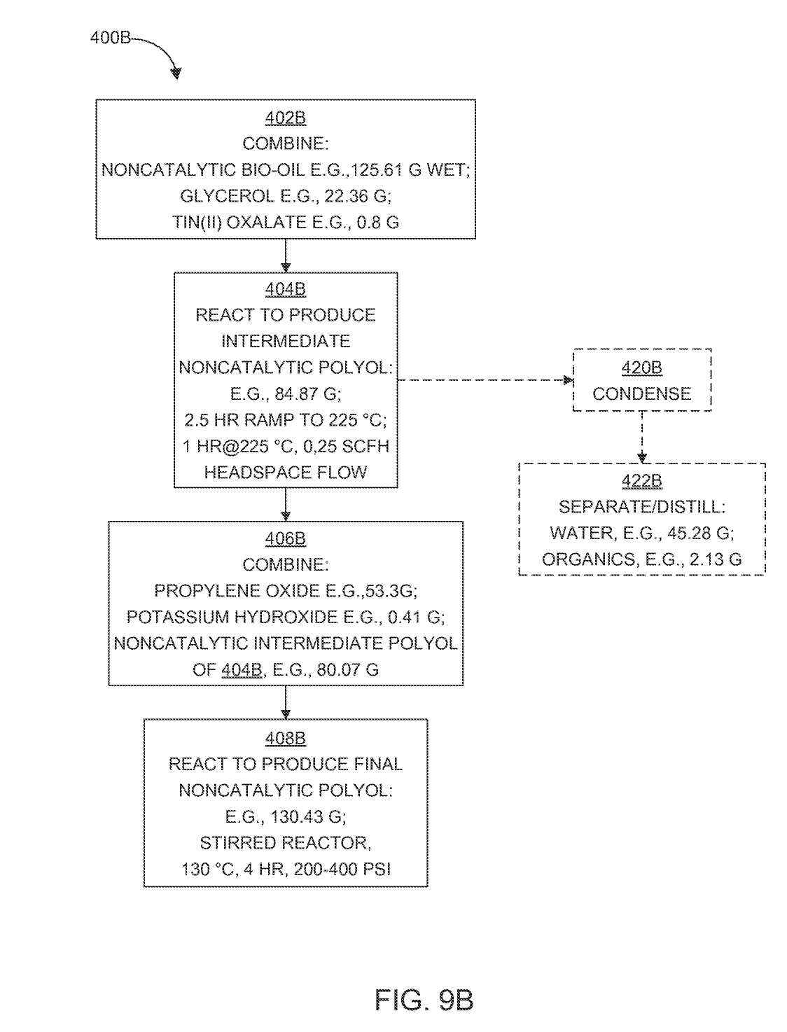

FIG. 9A is a flow diagram outlining an example method 400A described in EXAMPLE 4A. Reagents were (402A) combined in a reactor, including about 120.67 g of catalytically-produced bio-oil, about 12.71 g of glycerol, and about 0.08 g of tin (II) oxalate. The combined reagents were (404A) reacted by heating the reactor at about 225° C. for 2.5 hours. The reaction was held for 1 hour under 0.25 SCFH of argon headspace flow. Vapor evolved from the reaction (404A) were (420A) condensed and (422A) separated to provide about 1.24 g of water and about 36.36 g of organic distillate. The reaction (404A) was cooled and about 90.52 g of catalytic intermediate bio-oil polyol was isolated. About 53.3 g of propylene oxide, about 0.41 g of potassium hydroxide, and about 80.03 g of the catalytic intermediate bio-oil polyols from (404A) were (406A) combined in a stirred tank reactor. The combined reagents were (408A) reacted in the stirred tank reactor for about 4 hours at about 130° C. and about 200-400 psi of argon. Upon cooling, about 130.96 g of alkoxylated catalytic bio-oil polyol was isolated.

### Example 4B

### Modification of Non-Catalytic Bio-Oil Produces Non-Catalytic Intermediate Bio-Oil Polyol; Alkoxylation Produces Alkoxylated Non-Catalytic Bio-Oil Polyol

FIG. 9B is a flow diagram outlining an example method 400B described in EXAMPLE 4B. Reagents were (402B) combined in a reactor, including 125.61 g of wet, non-catalytically-produced bio-oil, about 22.36 g of glycerol, and about 0.08 g of tin (II) oxalate. The combined reagents were (404B) reacted by heating the reactor at about 225° C. for 2.5 hours, then the reaction was held for 1 hour under 0.25 standard cubic feet per hour (SCFH) of argon headspace flow. Vapor evolved from the reaction (404B) was (420B) condensed and (422B) separated to provide about 45.28 g of water and about 2.13 g of organic distillate. The reaction (404B) was cooled and about 84.87 g of non-catalytic intermediate bio-oil polyol was isolated. About 53.3 g of propylene oxide, about 0.41 g of potassium hydroxide, and about 80.07 g of the catalytic intermediate bio-oil polyols from (404B) were (406B) combined in a stirred tank reactor. The combined reagents were (408B) reacted in the stirred tank reactor for about 4 hours at about 130° C. and about 200-400 psi of argon. Upon cooling, about 130.43 g of alkoxylated non-catalytic bio-oil polyol was isolated.

### Example 5

### Alkoxylation of Catalytic Intermediate Bio-Oil Polyol Produces Alkoxylated Catalytic Bio-Oil Polyol

A reaction mixture was formed in an autoclave reactor by combining about 2105.38 g of the intermediate bio-oil polyol of EXAMPLE 2A and about 17.63 g of potassium hydroxide. The reaction mixture was heated at about 140° C. and then stirred in an autoclave after being flushed with argon. About 1386.22 g of propylene oxide were added with a dose meter in order to maintain a pressure of less than 50 psi. The reactor was held at 140° C. for 4 hours after addition of the propylene oxide. The reaction mixture was cooled to ambient temperature to result in an alkoxylated bio-oil polyol, in the form of a tacky viscous liquid, derived from non-catalytically-produced bio-oil.

### Example 6A

### Modification of Catalytic Bio-Oil Produces Catalytic Intermediate Bio-Oil Polyol

About 60.93 g of catalytically-produced bio-oil was reacted with itself in the presence of about 0.04 g of tin (II) oxalate. The reaction was heated at about 225° C. for 4 hours. The reaction was then held for 40 minutes, after which 0.25 standard cubic feet per hour (SCFH) of argon headspace flow was added for 1 hour. The material was poured into a silicone mold and broken once cooled to result in an intermediate bio-oil polyol as a glassy solid.

### Example 6B

### Alkoxylation of Catalytic Intermediate Bio-Oil Polyol Produces Alkoxylated Catalytic Bio-Oil Polyol

A reaction mixture was formed in an autoclave reactor by combining about 19.97 g of the intermediate bio-oil polyol of EXAMPLE 6A, about 13.39 g of propylene oxide, and about 0.13 g of potassium hydroxide. The reaction mixture was stirred in the autoclave under about 200 psi of argon for 1 hour. The autoclave reactor was then heated at about 130° C. and a pressure of about 450 psi, and the reaction mixture was stirred for an additional 4 hours. The reaction mixture was cooled to ambient temperature to result in an alkoxylated bio-oil polyol as a tacky viscous liquid, derived from catalytically-produced bio-oil.

### Example 7A

### Alkoxylation of Catalytic Intermediate Bio-Oil Polyol Produces Alkoxylated Catalytic Bio-Oil Polyol

A reaction mixture was formed in an autoclave reactor by combining about 60.30 g of the intermediate bio-oil polyol of EXAMPLE 1A, about 9.08 g of sucrose, about 10.62 g of glycerol, about 139.97 g of propylene oxide, and about 0.33 g of potassium hydroxide. The reaction mixture was stirred in the autoclave under about 200 psi of argon for 1 hour. The autoclave reactor was then heated at about 130° C. and a pressure of about 450 psi, and the reaction mixture was stirred for an additional 4 hours. The reaction mixture was cooled to ambient temperature to result in a liquid alkoxylated bio-oil polyol derived from catalytically-produced bio-oil.

### Example 7B

### Alkoxylated Catalytic Bio-Oil Polyol is a 100% Replacement for Petroleum Polyol in Rigid Foam

A foamable reaction mixture was formed using 50 parts of the alkoxylated bio-oil polyol derived from catalytically-produced bio-oil of EXAMPLE 7A. Also added to the reaction mixture was about 2.25 parts of water, about 2 parts of a silicone surfactant (DABCO® DC193, Air Products, Allentown, Pa.), about 0.5 parts 33% triethylene diamine in 67% dipropylene glycol (DABCO® 33-LV, Air Products, Allentown, Pa.), about 0.16 parts of 70 percent bis(2-dimethylaminoethyl) ether in 30 weight percent dipropylene glycol (Niax* catalyst A-1, Momentive, Columbus Ohio), and about 80.15 parts of 4,4′-diphenylmethane diisocyanate containing isomers and oligomers (LUPRANATE® M20S, BASF, Florham Park, N.J.). The components of the reaction mixture were combined at the same time, except for the 4,4′-diphenylmethane diisocyanate, which was added last. See also table 300 in FIG. 3, column 302. Compared to EXAMPLE 3A, the present example represents replacement of about 100% of the petroleum polyol with the alkoxylated bio-oil polyol derived from catalytically-produced bio-oil.

### Example 8A

### Modification of Non-Catalytic Bio-Oil Produces Non-Catalytic Intermediate Bio-Oil Polyol

About 957.87 g of non-catalytically-produced bio-oil was reacted with about 359.07 g of glycerol in the presence of about 0.73 g of tin (II) oxalate. The reaction was heated at about 225° C. for 4 hours. The reaction was then held for 40 minutes, after which 0.25 standard cubic feet per hour (SCFH) of argon headspace flow was added for 1 hour. The material was poured into a jar to result in an intermediate non-catalytic bio-oil polyol as a viscous liquid.

### Example 8B

### Alkoxylation of Non-Catalytic Intermediate Bio-Oil Polyol Produces Alkoxylated Catalytic Bio-Oil Polyol

A reaction mixture was formed in an autoclave reactor by combining about 457.50 g of the intermediate bio-oil polyol of EXAMPLE 8A, about 32.84 g of sucrose, about 600.91 g of propylene oxide, and about 3.21 g of potassium hydroxide. The reaction mixture was stirred in the autoclave under about 180 psi of argon for 1 hour. The autoclave reactor was then heated at about 130° C. and the reaction mixture was stirred for an additional 4 hours. The reaction mixture was cooled to ambient temperature to result in an alkoxylated bio-oil polyol as a viscous liquid, derived from non-catalytically-produced bio-oil.

### Example 8C

### Alkoxylated Non-Catalytic Bio-Oil Polyol is a 100% Replacement for Petroleum Polyol in Rigid Foam

A foamable reaction mixture was formed using 50 parts of the alkoxylated bio-oil polyol derived from non-catalytically-produced bio-oil of EXAMPLE 8B. Also added to the reaction mixture was about 2.25 parts of water, about 2 parts of the silicone surfactant (DABCO® DC193, Air Products, Allentown, Pa.), about 0.5 parts 33% triethylene diamine in 67% dipropylene glycol (DABCO® 33-LV, Air Products, Allentown, Pa.), about 0.16 parts of 70 percent bis(2-dimethylaminoethyl) ether in 30 weight percent dipropylene glycol (Niax* catalyst A-1, Momentive, Columbus Ohio), and about 78.70 parts of 4,4′-diphenylmethane diisocyanate containing isomers and oligomers (LUPRANATE® M20S, BASF, Florham Park, N.J.). The components of the reaction mixture were combined at the same time, except for the 4,4′-diphenylmethane diisocyanate, which was added last. The mixture was reacted at ambient temperature to form a polyurethane foam composition characterized by a density of 1.93 g/cubic centimeter and a maximum load in psi of 119.0±13.4. See also table 300 in FIG. 3, column 302. Compared to EXAMPLE 3A, the present example represents replacement of about 100% of the petroleum polyol with the alkoxylated bio-oil polyol derived from non-catalytically-produced bio-oil.

### Example 9

### Formation of Phenol-Formaldehyde Type Resin Using Catalytically Produced Bio-Oil

A reaction mixture was formed by combining about 113.63 g of catalytic bio-oil, about 31.29 g of 37 weight % formaldehyde, and about 0.75 g of solid potassium hydroxide in a flask containing a stir bar. A short path distillation apparatus, thermocouple, gas inlet, and heating mantle were attached to the flask. The reaction was stirred and heated to 80° C. for 1 hour and then stirred and heated at about 130° C. for about 1 hour while distilling water out of the reaction mixture. The temperature was held for 30 minutes and the reaction mixture remaining in the flask was poured into a silicone mold. The resulting tacky viscous liquid phenol-formaldehyde type resin from the silicone mold was placed between two tongue depressors and pressed at about 232° C. to provide a cured phenol-formaldehyde type resin containing the catalytic bio-oil as a phenol source.

### Prophetic Example 10A

### Phenol-Formaldehyde-Urea Type Resin Formed Using Catalytically Produced Bio-Oil

A reaction mixture may be formed by combining about 115 g of catalytic bio-oil, about 32 g of 37 weight % formaldehyde, and about 0.75 g of solid potassium hydroxide in a flask containing a stir bar. A short path distillation apparatus, thermocouple, gas inlet, and heating mantle may be attached to the flask. The reaction may be stirred and heated at about 80° C. for about 1 hour and may be stirred and heated at about 130° C. for 1 hour, while distilling water out of the reaction mixture. The temperature may be held for about 30 minutes. An amount of urea of between about 0.1 g and about 42 g may be added to the reaction mixture, and stirred at about 130° C. for about 1 hour. The resulting reaction mixture remaining in the flask may be poured into a silicone mold to form the phenol-formaldehyde-urea type resin containing the catalytic bio-oil as a phenol source. The resulting resin from the silicone mold may be pressed and heated at about 200-250° C. to provide a cured phenol-formaldehyde-urea type resin containing the catalytic bio-oil as a phenol source.

### Prophetic Example 10B

### Phenol-Formaldehyde-Urea Type Resin Formed Using Catalytically Produced Bio-Oil

A reaction mixture may be formed by combining about 32 g of 37 weight % formaldehyde, between about 18 and about 30 g of urea, and about 0.01 to about 1 g pyridine in a flask containing a stir bar. A short path distillation apparatus, thermocouple, gas inlet, and heating mantle may be attached to the flask. The reaction may be stirred and heated at about 80° C. for about 1 hour and may be then stirred and heated at about 130° C. for about 1 hour while distilling water out of the reaction mixture. About 115 g of catalytic bio-oil may be added to the resulting urea-formaldehyde reaction mixture, and stirred at about 130° C. for about 1 hour. The resulting mixture remaining in the flask may be poured into a silicone mold to form a phenol-formaldehyde-urea type resin containing the catalytic bio-oil as a phenol source. The resulting resin from the silicone mold may be pressed and heated at about 200-250° C. to provide a cured phenol-formaldehyde-urea type resin containing the catalytic bio-oil as a phenol source.

### Prophetic Example 11A

### Formation of Intermediate Bio-Oil Polyol

An intermediate polyol may be prepared by reacting bio-oil, for example catalytic bio-oil, with itself or with another polyol. For example, a sample of catalytic bio-oil may be combined to form a reaction mixture with between about 0 weight % and about 33 weight % of a reagent polyol, for example, about 12 weight % of glycerol. A catalyst may be added to the reaction mixture, for example, between about 0.01 weight % to about 5 weight %, e.g., about 0.05 weight % of tin(II) oxalate. The reaction mixture and catalyst may be stirred and heated at about 140° C. under an argon flow. The reaction mixture may be allowed to react until an acid value may be driven to less than about 3 milligrams potassium hydroxide per g equivalent. The resulting material may be poured into a silicone mold while hot. The resulting material may be cooled to ambient temperature in the mold and may be ground up to form a ground intermediate polyol.

### Example 11B

### Formation of Hot Melt Adhesive

A hot melt adhesive precursor mixture was prepared containing about 12.585 g of poly(bisphenol A) carbonate (molecular weight 2202), about 46.65 g of isophthalic acid dihydroquinone ester, about 0.496 g of 4-phenylphenol, and about 112.759 g of polycaprolactone diol, (molecular weight 1233). To the hot melt adhesive was added about 31.709 g of an intermediate polyol as crosslinker, for example the ground intermediate polyol of EXAMPLE 11A. The hot melt adhesive precursor mixture and the intermediate polyol were placed into a steel beaker and hand stirred at about 175° C. About 81.619 g of 4,4′-methylene bis(phenyl isocyanate) was then added to the reaction in the steel beaker. Thickening was observed starting at about 1.5 minutes followed by apparent reaction completion after about 4 minutes. The resulting intermediate polyol-cross-linked hot melt adhesive material was pressed into films at about 232° C.

### Prophetic Example 12A

### Crosslink Hardening of Cured and Uncured Resins

A cured or uncured resin according to any of EXAMPLES 9, 10A, or 10B may be hardened, for example using a crosslinker such as a polyamino alkylene compound such as hexamethylenetetramine. In one example, the tacky viscous liquid phenol-formaldehyde type resin from the silicone mold in EXAMPLE 9 may be combined with 0.01 weight % to about 10 weight % of hexamethylenetetramine, and heated to between about 200° C. and about 250° C. to form a cured, phenol-formaldehyde type cross-linked resin containing the catalytic bio-oil as a phenol source. In another example, the phenol-formaldehyde-urea type resin from the silicone mold in EXAMPLE 10A may be combined with 0.01 weight % to about 10 weight % of hexamethylenetetramine, and heated to between about 200° C. and about 250° C. to form a cured, phenol-formaldehyde-urea type cross-linked resin containing the catalytic bio-oil as a phenol source. In a further example, the phenol-formaldehyde-urea type resin from the silicone mold in EXAMPLE 10B may be combined with 0.01 weight % to about 10 weight % of hexamethylenetetramine, and heated to between about 200° C. and about 250° C. to form a cured, phenol-formaldehyde-urea type cross-linked resin containing the catalytic bio-oil as a phenol source.

### Prophetic Example 13

### Formation of Cured, Phenol-Formaldehyde-Urea Type Extruded Resin

An extrusion may be formed starting with an incompletely cured resin according to any of EXAMPLES 9, 10A, 10B, or 11B, starting with a preheated extruder, for example, preheated to between about 200° C. and about 250° C. In an example, the tacky viscous liquid phenol-formaldehyde type resin from the silicone mold in EXAMPLE 9 may be loaded into the preheated extruder and extruded to form a cured, phenol-formaldehyde type extruded resin article containing the catalytic bio-oil as a phenol source. In another example, the phenol-formaldehyde-urea type resin from the silicone mold in EXAMPLE 10A may be loaded into the preheated extruder and extruded to form a cured, phenol-formaldehyde-urea type extruded resin article containing the catalytic bio-oil as a phenol source. In another example, the phenol-formaldehyde-urea type resin from the silicone mold in EXAMPLE 10B may be loaded into the preheated extruder and extruded to form a cured, phenol-formaldehyde-urea type extruded resin article containing the catalytic bio-oil as a phenol source. In a further example, the intermediate polyol-cross-linked hot melt adhesive material from the steel beaker in EXAMPLE 11B may be loaded into the preheated extruder and extruded to form a cured, intermediate polyol-cross-linked hot melt extruded article containing the catalytic bio-oil as crosslinker.

### Example 14

### Phenol-Formaldehyde-Urea Type Resin Formed Using Catalytically Produced Bio-Oil

A reaction mixture was formed by combining about 151.16 g of catalytic bio-oil and about 53.56 g of 37 weight % formaldehyde in a flask containing a stir bar. A Barrett tube with condenser, thermocouple, gas inlet, and heating mantle were attached to the flask. The reaction was stirred, and about 10.23 g of urea was added to the bio-oil mixture. The mixture was then heated to 80° C. for 3 hours followed by heating at about 130° C. for about 40 min, while distilling water out of the reaction mixture. The temperature was held for about 5 minutes. The resulting reaction mixture remaining in the flask was poured into a silicone mold to form the phenol-formaldehyde-urea type resin containing the catalytic bio-oil as a phenol source. The resulting resin from the silicone mold was pressed into a 118^{th} inch panel at 110° C. in a 90% sawdust and 10% resin mixture. The mixture may also be pressed up to about 250° C. to provide a cured phenol-formaldehyde-urea type resin containing the catalytic bio-oil as a phenol source.

### Example 15

### Production of Alkoxylated Bio-Oil

A reaction mixture was formed in an autoclave reactor by combining about 60.30 g of the intermediate bio-oil polyol of EXAMPLE 1A, about 9.08 g of sucrose, about 4.82 g of glycerol, about 139.97 g of propylene oxide, and about 0.33 g of potassium hydroxide. The reaction mixture was stirred in an autoclave under about 200 psi of argon for 1 hour. The autoclave reactor was then heated at about 130° C. and a pressure of about 450 psi, and the reaction mixture was stirred for an additional 4 hours. The reaction mixture was cooled to ambient temperature to result in an alkoxylated bio-oil polyol, derived from catalytically-produced bio-oil as a liquid.

### Example 16

### Production of Intermediate Bio-Oil Polyol

About 150.30 g of catalytically-produced bio-oil was reacted with about 50.39 g of glycerol in the presence of about 0.10 g of tin (II) oxalate. The reaction was heated to about 225° C. over 4 hours. The reaction was held for 1 hour, after which 0.25 SCFH of argon headspace flow was added for 1 hour. The material was poured into a silicone mold, cooled, and transferred to jar to result in an intermediate bio-oil polyol as a taffy-like mass.

### Example 17

### Production of Alkoxylated Bio-Oil Polyol

A reaction mixture was formed in an autoclave reactor by combining about 40.95 g of the intermediate bio-oil polyol of EXAMPLE 16, about 5.76 g of sucrose, about 79.16 g of propylene oxide, and about 0.12 g of potassium hydroxide. The reaction mixture was stirred in the autoclave under about 200 psi of argon for 1 hour. The autoclave reactor was then heated at about 130° C. and a pressure of about 450 psi, and the reaction mixture was stirred for an additional 4 hours. The reaction mixture was cooled to ambient temperature to result in an alkoxylated bio-oil polyol, derived from catalytically-produced bio-oil as a liquid.

### Example 18

### Production of Intermediate Bio-Oil Polyol

About 957.87 g of non-catalytically-produced bio-oil was reacted with about 357.07 g of glycerol in the presence of about 0.73 g of tin (II) oxalate. The reaction was heated to about 225° C. over 4 hours. The reaction was held for 1 hour, after which 0.25 SFCH of argon headspace flow was added for 1 hour. The material was poured into a jar to result in an intermediate bio-oil polyol as a taffy-like mass.

### Example 19

### Production of Alkoxylated Bio-Oil Polyol

A reaction mixture was formed in an autoclave reactor by combining about 457.50 g of the intermediate bio-oil polyol of EXAMPLE 18, about 32.84 g of sucrose, about 600.91 g of propylene oxide, and about 3.21 g of potassium hydroxide. The reaction mixture was stirred in the autoclave under about 180 psi of argon for 1 hour. The autoclave reactor was then heated at about 130° C. and the reaction mixture was stirred for an additional 4 hours. The reaction mixture was cooled to ambient temperature to result in an alkoxylated bio-oil polyol, derived from non-catalytically-produced bio-oil as a liquid.

### Example 20

### Production of Intermediate Bio-Oil Polyol

About 1569.50 g of non-catalytically-produced bio-oil, including water and oil layers, was reacted with about 301.45 g of glycerol in the presence of about 0.78 g of tin (II) oxalate. The reaction was heated to about 225° C. over 9 hours. The reaction was held for 1 hour, after which 0.25 SCFH of argon headspace flow was added for 1 hour. The material was poured into a jar to result in an intermediate bio-oil polyol as a taffy-like mass.

### Example 21

### Production of Alkoxylated Bio-Oil Polyol

A reaction mixture was formed in an autoclave reactor by combining about 549.76 g of the intermediate bio-oil polyol of EXAMPLE 20, about 674.00 g of propylene oxide, and about 3.34 g of potassium hydroxide. The reaction mixture was heated to 50° C. in the autoclave under about 5 psi and then stirred for 10 minutes. The autoclave reactor was then heated to about 130° C. and the reaction mixture was stirred for an additional 4 hours. The reaction mixture was cooled to ambient temperature to result in an alkoxylated bio-oil polyol, derived from non-catalytically-produced bio-oil as liquid.

### Example 22

### Production of Intermediate Bio-Oil Polyol

About 1569.43 g of non-catalytically-produced bio-oil, including water and oil layers, was reacted with about 300.70 g of glycerol in the presence of about 0.82 g of tin (II) oxalate. The reaction was heated to about 225° C. over 9 hours. The reaction was held for 1 hour, after which 0.25 SCFH of argon headspace flow was added for 1 hour. The material was poured into a jar to result in an intermediate bio-oil polyol as a taffy-like mass.

### Example 23

### Production of Alkoxylated Bio-Oil Polyol

A reaction mixture was formed in an autoclave reactor by combining about 550.06 g of the intermediate bio-oil polyol of EXAMPLE 22, about 443.84 g of propylene oxide, and about 3.00 g of potassium hydroxide. The reaction mixture was heated to 50° C. in an autoclave at a pressure of about 5 psi and then stirred for 10 minutes. The autoclave reactor was then heated to about 130° C. and the reaction mixture was stirred for an additional 4 hours. The reaction mixture was cooled to ambient temperature to result in an alkoxylated bio-oil polyol, derived from non-catalytically-produced bio-oil as viscous liquid.

### Prophetic Example 24

### Production of Intermediate and Final Polyols in Single Pot Reaction

About 1569.43 g of non-catalytically-produced bio-oil, including water and oil layers, may be reacted with about 300.70 g of glycerol in the presence of about 0.82 g of tin (II) oxalate. The reaction may be heated to about 225° C. over 9 hours. The reaction may be held for 60 minutes, after which 0.25 standard cubic feet per hour (SCFH) of argon headspace flow may be added for 1 hour. The reaction mixture may then be cooled to 130° C. and about 6.03 g of potassium hydroxide may be added with stirring. About 1201.43 g of propylene oxide may then be delivered slowly by a pump in order to maintain the desired reactor pressure. Once addition is completed, the reaction temperature may be maintained until the reaction completes. The reaction mixture may then be cooled to ambient temperature to result in an alkoxylated bio-oil polyol, derived from non-catalytically-produced bio-oil as viscous liquid.

### Example 25A

A sample of a bio-oil starting material high in lignin content (“ESP”) was provided. About 73.20 grams of the bio-oil starting material were mixed with about 6.28 grams of 2-methyl-1,3-propanediol and about 0.04 grams of tin (II) oxalate catalyst to form a reaction mixture. The reaction mixture was stirred in an autoclave at about 140° C. under an argon flow. The reaction mixture was allowed to react until the acid value was driven to about 2.62 milligrams potassium hydroxide per gram equivalent. The resulting material was poured into a silicone mold while hot. Once cooled to ambient temperature, the resulting polyol bio-oil product was ground up and placed into a jar. The ground polyol bio-oil product was characterized by a hydroxyl value of 237.4.

### Example 25B

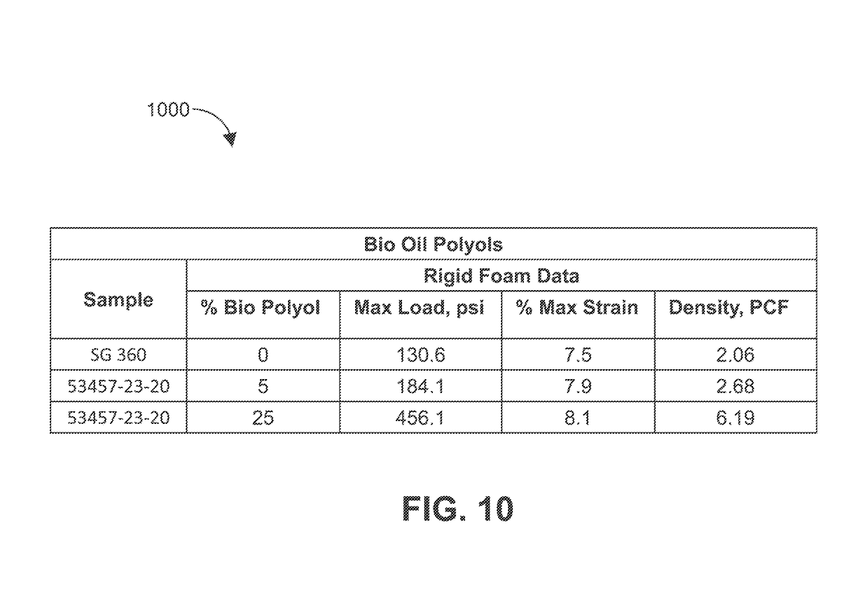

The ground polyol bio-oil product of EXAMPLE 25A was then formed into a rigid foam by replacing a standard petroleum based polyol with varying amounts of the ground polyol bio-oil product as described in Table 1000 in FIG. 10. As can be seen in Table 1000 in FIG. 10, employing the ground polyol bio-oil product led to high foam densities and high foam load properties.

### Example 26A

A sample of a bio-oil starting material high in lignin content (“ESP”) was provided. About 133.29 grams of the bio-oil starting material was reacted with 16.98 grams of 2-methyl-1,3-propanediol and 0.07 grams of tin (II) oxalate to form a reaction mixture. The reaction mixture was stirred in an autoclave at about 140° C. under an argon flow. The reaction mixture was allowed to react until the acid value was driven to about 2.15 milligrams potassium hydroxide per gram equivalent. The resulting material was poured into a silicone mold while hot. Once cooled to ambient temperature, the resulting product was a soft semi-solid polyol bio-oil product. The soft semi-solid polyol bio-oil product was characterized by a hydroxyl value of 278.2.

### Example 26B

About 15 grams of the polyol of EXAMPLE 26A was combined with about 3.88 grams propylene oxide and about 0.11 grams of potassium hydroxide as catalyst to form a reaction mixture. The reaction mixture was reacted in an autoclave under about 100 pounds per square inch argon at about 130° C. for about 3.5 hours. The resulting viscous polyol/polyester composition was characterized by an acid value less than about 1 milligram potassium hydroxide per gram equivalent.

### Example 27A

A sample of a bio-oil starting material high in lignin content (“ESP”) was provided. About 120.01 grams of the bio-oil starting material were mixed with about 9.37 grams of glycerol and about 0.07 grams of tin (II) oxalate catalyst to form a reaction mixture. The reaction mixture was stirred in an autoclave at about 140° C. under an argon flow. The reaction mixture was allowed to react until the acid value was driven to about 3.68 milligrams potassium hydroxide per gram equivalent. The resulting polyol bio-oil product was a solid characterized by a melting temperature just above ambient temperature. The resulting polyol bio-oil product was characterized by a hydroxyl value of about 267.

### Example 27B

About 15 grams of the polyol bio-oil product of EXAMPLE 27A may be combined with about 2.94 grams ethylene oxide and about 0.11 grams of potassium hydroxide as catalyst to form a reaction mixture. The reaction mixture may be reacted in an autoclave under about 100 pounds per square inch argon at about 130° C. for about 3.5 hours. The resulting polyol/polyester composition may be characterized by an acid value less than about 1 milligram potassium hydroxide per gram equivalent.

### Example 28

Samples of each of the resulting polyol bio-oil products of EXAMPLES 25A, 26A, and 27A, or polyol/polyester compositions of EXAMPLES 26B and 27B may be obtained. Each of these samples may be independently contacted with a polyisocyanate such as toluene diisocyanate, and optionally a catalyst, such as tin(II) oxalate to form a polyurethane forming reaction mixture. The reaction mixture may be allowed to react under suitable conditions, for example, heating between about ambient temperature and about 140° C. for 5 minutes to 5 hours. A resulting polyurethane product composition may be obtained on cooling.

### Example 29

Samples of each of the resulting polyol bio-oil products of EXAMPLES 25A, 26A, and 27A may be observed to be colored. The samples of each of the resulting polyol bio-oil products of EXAMPLES 25A, 26A, and 27A may be independently contacted with a suitable solvent, such as tetrahydrofuran or an alcohol, to form corresponding polyol bio-oil product solutions. The corresponding polyol bio-oil products or solutions thereof may be independently decolorized, for example, by contacting the corresponding products or solutions with decolorizing carbon, stirring for a period of time, filtering to remove the decolorizing carbon (and removing the suitable solvent if present) to leave a corresponding decolorized polyol bio-oil product.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third and upper third, and the like. As will also be understood by one skilled in the art all language such as “up to,” “at least,” “greater than,” “less than,” include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles. A “per”-substituted compound or group is a compound or group having all or substantially all substitutable positions substituted with the indicated substituent. For example, 1,6-diiodo perfluoro hexane indicates a compound of formula C₆F₁₂I₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (e.g., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tert-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The term “amine” (or “amino”), as used herein, refers to NR₅R₆ groups, wherein R₅ and R₆ may be independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine may be alkylamino, dialkylamino, arylamino, or alkylarylamino. In other embodiments, the amine may be NH₂, methylamino, dimethylamino, ethylamino, diethylamino, propylamino, isopropylamino, phenylamino, or benzylamino. The term “alkylamino” may be defined as NR₇R₈, wherein at least one of R₇ and R₈ may be alkyl and the other may be alkyl or hydrogen. The term “arylamino” may be defined as NR₉R₁₀, wherein at least one of R₉ and R₁₀ may be aryl and the other may be aryl or hydrogen.

The term “halogen” or “halo,” as used herein, refers to bromine, chlorine, fluorine, or iodine. In some embodiments, the halogen may be fluorine. In other embodiments, the halogen may be chlorine or bromine.

The various aspects and embodiments disclosed herein are for purposes of illustration and are not intended to be limiting, with the true scope and spirit being indicated by the following claims.

1-157. (canceled)

158. A method for preparing an alkoxylated bio-oil polyol, the method comprising:
providing a bio-oil polyol; and
reacting the bio-oil polyol in the presence of a catalyst under reaction conditions effective to form the alkoxylated bio-oil polyol with one or more of:
a cyclic alkylene oxide; and
a reagent polyol.

159. The method of claim 1, the cyclic alkylene oxide comprising one or more of:
unsubstituted ethylene oxide or ethylene oxide substituted with a linear or branched C₁-C₆ alkyl group or a C₃-C₆ cycloalkyl group;
1,2-propylene oxide;
a weight % compared to a weight of the bio-oil polyol of between about 5 weight % and about 70 weight %; and
a weight % compared to a weight of the bio-oil polyol of greater than 10 weight %.

160. The method of claim 158, the reaction conditions comprising one or more of:
a presence of a catalytic alkali metal hydroxide or a catalytic alkali earth metal hydroxide or oxide;
a presence of a catalytic amount of potassium hydroxide;
a presence of a catalyst in a weight % compared to a weight of the bio-oil polyol of between about 0.01 weight % and about 5 weight %;
a temperature between about 80° C. and about 180° C.;
a pressure in pounds per square inch of between about 0 and about 600; and
a presence of an acidified lignin.

161. The method of claim 158,
the bio-oil polyol comprising one or more of: a bio-oil; an intermediate bio-oil polyol comprising the bio-oil modified by reaction with the bio-oil; and the intermediate bio-oil polyol comprising the bio-oil modified by reaction with a reagent polyol; and
the bio-oil comprising one or more of: the bio-oil produced by pyrolysis of biomass or a catalytic bio-oil produced by catalytic pyrolysis of biomass.

162. The method of claim 161, further comprising pyrolyzing biomass to provide the bio-oil or catalytically pyrolyzing the biomass to provide the bio-oil as a catalytic bio-oil.

163. The method of claim 158, further comprising reacting a bio-oil with at least one of the bio-oil or the reagent polyol in the presence of a polyol-forming catalyst to provide the bio-oil polyol.

164. The method of claim 158, the reagent polyol comprising one or more of glycerol, ethylene glycol, propylene glycol, 1,3-propanediol, 2-methyl-1,3-propanediol, pentaerythritol, a sugar alcohol, an alcohol amine, a polyalkylene glycol, an alkylene glycol, a polyethylene glycol, a polypropylene glycol, a poly(tetramethylene ether) glycol, acidified and demethylated crude glycerol, and wet crude glycerol from steam splitting.

165. The method of claim 158, the catalyst comprising tin.

166. The method of claim 158, the catalyst comprising tin (II) oxalate.

167. A method for producing a polymer composition, the method comprising:
providing a polymerization precursor mixture configured to form a polymer in combination with an alkoxylated bio-oil polyol; and
reacting the alkoxylated bio-oil polyol with the polymerization precursor mixture under reaction conditions effective to form the polymer composition.

168. The method of claim 167, the polymerization precursor mixture comprising a polyurethane precursor comprising one or more of toluene diisocyanate, methylene diphenyl diisocyanate, 1,6-hexamethylene diisocyanate, 1-isocyanato-3-isocyanatomethyl-3,5,5-trimethyl-cyclohexane, and 4,4′-diisocyanato dicyclohexylmethane.

169. The method of claim 167, the polymerization precursor mixture comprising one or more of: a petroleum polyol, water, a foam-forming surfactant, a trialkylamine, a polyamino alkane, a polyalkylamino alkyl ether, an antioxidant, a flame retardant, an ultraviolet light stabilizer, a pigment, a dye, and a plasticizer.

170. The method of claim 167, the polymerization precursor mixture comprising a polyfunctional ester precursor effective to form the polymer composition comprising a polyester, the polyfunctional ester precursor comprising one or more of: a polycarboxylic acid, a polyacyl halide, and a cyclic anhydride.

171. The method of claim 167, the reaction conditions comprising one or more of:
a presence of a catalyst for one or more of: polyester polymerization, polyurethane polymerization, and phenolic resin formation;
a temperature between about 0° C. and about 180° C.;
a pressure in pounds per square inch of between about 15 and about 600; and
a presence of a viscosity-reducing modifier.

172. The method of claim 167, the polymerization precursor mixture comprising an aliphatic phenolic resin precursor and a phenolic resin catalyst effective to produce the polymer composition comprising a phenolic resin.

173. The method of claim 167, the aliphatic phenolic resin precursor comprising one or more of: a reactive carbonyl compound, a reactive carbonyl compound that is at least partly water soluble, a urea derivative, a formaldehyde-urea resin, formaldehyde, acetaldehyde, propionaldehyde, butyraldehyde, glyoxal, propane-1,3-dial, butane-1,4-dial, glutaraldehyde, acetone, 2-butanone, 2-pentanone, 3-pentanone, butane-2,3-dione, and pentane-2,4-dione.

174. The method of claim 167, further comprising configuring the polymer composition as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, or an integral skin foam.

175. A polymer composition, produced by a process comprising:
providing a polymerization precursor mixture configured to form a polymer in combination with an alkoxylated bio-oil polyol; and
reacting the alkoxylated bio-oil polyol with the polymerization precursor mixture under reaction conditions effective to form the polymer composition.

176. The polymer composition of claim 175, comprising one or more of: a polyurethane, a polyester, and a phenolic resin.

177. The polymer composition of claim 175, configured as one or more of: a foam, a spray foam, an extrusion, an injection molding, a coating, an adhesive, an elastomer, a foundry resin, a sealant, a casting, a fiber, a potting compound, a reaction injection molded (RIM) plastic, a microcellular elastomer or foam, and an integral skin foam.
